(19) United States
(12) Patent Application Publication
(10) Pub. No.: US 2026/0252994 A1
(43) Pub. Date: Aug. 27, 2026

(54) SYSTEM AND METHOD FOR AUTONOMOUS AGENTIC WORKFLOW EXECUTION IN EXPERIENCE AUTOMATION PLATFORMS

(71) Applicant: Ushur, Inc., Santa Clara, CA (US)

(72) Inventors: Henry Thomas Peter, Mountain House, CA (US); Aravindh Mattipa Dorappa, San Jose, CA (US); Simha Sadasiva, San Jose, CA (US); Vijayendra Mysore Shamanna, Cupertino, CA (US); Nishad Singh, San Francisco, CA (US); Barry Tallis, Montverde, FL (US)

(21) Appl. No.: 19/551,353

(22) Filed: Feb. 26, 2026

Related U.S. Application Data
(60) Provisional application No. 63/764,504, filed on Feb. 27, 2025.

(51) Int. Cl. G06Q 10/0631; G06F 9/451; G06Q 10/0633

(52) U.S. Cl. CPC G06Q 10/06316; G06F 9/451; G06Q 10/0633

(57) ABSTRACT

Agentic Experience Automation (AXA) is a novel system for dynamic, autonomous workflow execution within enterprise environments. AXA introduces a Multi-Agent System where specialized AI agents, tailored to specific industry verticals, leverage a fine-tuned language model provided by an AXA vendor to reason, plan, and act independently. The system employs AXA Declarations, a proprietary declarative framework, to translate high-level intents into actionable workflows, allowing the AI agents to adapt execution in real time based on contextual data, end-user interactions, and industry-specific requirements. The system seamlessly integrates security and compliance mechanisms into AI Agents. The AI Agents encapsulate all platform functions, workflows, and policies, dynamically adjusting to specific industry needs. Additionally, AXA supports a hybrid execution model, combining the predictability of rule-based micro-engagement engines with the flexibility of agentic oversight. Extensibility through plug-in components for future functions and dynamic policy modules ensures scalability, adaptability, and compliant with evolving industry standards.

### RELATED APPLICATIONS

This application claims priority to U.S. Provisional Patent Application 63/764,504, filed Feb. 27, 2025, which is incorporated by reference herein.

### COPYRIGHT NOTICE

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever.

### TECHNICAL FIELD

The present disclosure generally relates to customer engagement automation, and specifically to the area of enhancing customer experiences using autonomous agentic workflow, especially in the regulated industries. The agentic workflow may include knowledge work that involves document handling, extraction automation as well as intelligent conversation, bringing an appropriate customer experience for a modern consumer.

### BACKGROUND

The Applicant of the current patent application disclosed a micro-engagement platform in an earlier patent application, titled, “System and Methods for a Micro-Engagement Platform,” which issued on Mar. 1, 2022 as U.S. Pat. No. 11,263,666. The entirety of U.S. Pat. No. 11,263,666 is incorporated herein by reference. The micro-engagement platform transmits a snippet of information to an end-user's device (that can be a mobile device or a desktop) that can be viewed and responded to quickly. Upon completion of one micro-engagement by the end-user, the platform serves the next micro-engagement and eventually serves a sequence of micro-engagements, thereby achieving the overall goal of user engagement and establishing enterprise workflows. Micro-engagement platform gives the end-user flexibility in mode of engagement rather than getting them stuck with a committed mode of engagement, such as Interactive Voice Response (IVR) or desktop web chat. In short, micro-engagement platform is a mechanism that is designed to bring compelling end-user experiences with the primary objective of bringing in end-user conversions and closures in getting responses and information from the end-users for an enterprise who provides services or goods to the end-user. Note that the end-user is the ultimate consumer of the service or good.

With the rise of the Large Language Models (LLM) and the generative capability of an Artificial Intelligence (AI)-powered platform, the existing micro-engagement capabilities can be enhanced in a consumer-friendly way, if an appropriate set of questions are asked, adequate responses are provided to advance interaction, and/or proper interfaces are provided to the end-user to express their needs. End-user's interest in providing information depends a lot on the enterprise persona with whom the end-user is engaging. Therefore, the enterprise persona needs to be empowered with tools to generate fitting engagement texts. Note that

To address this need, the Applicant of the current application came up with a proprietary solution which is protected by U.S. Provisional Patent Application No. 63/584,315, filed Sep. 21, 2023, titled “Generative Customer Experience Automation,” which has been converted to U.S. Non-Provisional patent application Ser. No. 18/889,015 on Sep. 18, 2024, and is incorporated herein in its entirety by reference. The disclosure on Generative Customer Experience Automation (CXA), sometimes shortened as “GenCXA,” presented visual interfaces as well as underlying methods and systems for bringing generative automated customer experiences to the enterprises and their end-users.

At the core of the CXA platform is the patented micro-engagement system. A visual workflow builder is part of the micro-engagement system that allows for creation of workflows without writing any code. The existing version of the generic micro-engagement platform is enhanced in this patent application to support an environment where the content of the micro-engagement can be generated, presented and selected by an enterprise persona and launched to the end-users. The generated content is more dialog-friendly and is based on a set of parameters around specific workflows and prior practices brought about by Large Language Models or other relatively smaller but more domain-specific fine-tuned language models. End-users can also input their descriptions through which apt workflows can be dynamically generated at runtime, thereby personalizing the end-user's engagement experience further. This revolutionary capability enhances enterprise's services by offering a new service that the enterprise persona could not expect to be required at the workflow creation time, as the end-user's intent was not fully known during workflow creation time.

In one aspect, the GenCXA disclosure involves providing a novel set of high-level visual interfaces to an enterprise persona with an ultimate goal of empowering the end-users to create and/or propagate automated workflows. The high-level interfaces given to the enterprise persona enables the persona to generate an effective engagement text (that can be converted into other mediums such as voice, if required) to their end-users with a mere description or a mere selection of a preference. This way the enterprise persona can initiate an entire workflow that can be launched. The enterprise persona is given options to explicitly give tools for end-users to be able to customize workflow, while the underlying system remains open and the global generative capability is allowed for end-users.

In a key aspect, the GenCXA disclosure permits the enterprise to present a playground of all necessary ingredients including data and hooks for their consumers (end-users). The end-users, through a mere description of what they need, are enabled to internally generate workflows and enhance a more personalized experience for themselves. In short, this disclosure permits a micro-engagement platform to enhance customer service experience by leveraging the end-user's intent to create intelligent workflows at runtime within an enterprise. These are workflows that have not been provided by the enterprise; rather these workflows are created from the end-user's preference at the runtime, thereby taking the personalization of the micro-engagement platform to a new level.

The enhanced micro-engagement platform gets more suggestive and creative in understanding end-users'inputs and taking appropriate actions, such as intelligently responding to the end-user, validating end-user's response, and/or generating a completely new service at the runtime.

The prior disclosure of GenCXA revolutionized workflow creation by enabling enterprise personas—such as business users or citizen developers—to generate engagement texts and entire workflows through natural language descriptions or preference selections, eliminating the need for manual configuration or coding. Workflow creation extended beyond enterprises, empowering end-users to generate personalized workflows dynamically, marking a fundamental shift from rigid, enterprise-controlled automation to LLM-powered, user-driven experience automation.

However, while workflow creation became dynamic and generative, workflow execution remained static. Even when executed through the Micro-Engagement Engine, workflows still followed a predefined, rule-based execution model with no real-time adaptability. Although workflows were generated using vendor's LLM, trained on novel automation concepts, best practices, and enterprise logic, the execution process itself did not evolve—it functioned just as it would in traditional automation systems, lacking the ability to adapt dynamically to changing conditions, user interactions, or business needs.

In this disclosure, the next evolution in autonomous workflow is described, which is termed as the Agentic Experience Automation (AXA). AXA extends this innovation beyond workflow creation to workflow execution, introducing autonomous AI agents that dynamically interpret, modify, and optimize workflows in real-time. Unlike Generative CXA, which generated intelligent workflows but relied on static execution, AXA ensures that execution itself becomes intelligent, goal-driven, and self-optimizing, allowing enterprises to achieve true AI-powered experience automation.

### SUMMARY

Embodiments described herein provide systems and methods for customer engagement automation using an autonomous agentic workflow.

In one aspect, a multi-agentic system for executing workflows in an experience automation platform includes a memory and a set of one or more processing devices coupled to the memory, where the set of one or more processing devices is to identify a workflow corresponding to a user request. The set of one or more processing devices is further to determine a set of declarations corresponding to the workflow, where each of the declarations is associated with an artificial intelligence (AI) agent of multiple AI agents. The set of one or more processing devices is further to identify a set of AI agents, where each AI agent in the set is associated with a declaration of the set of declarations. The set of one or more processing devices is further to assign, to each of the set of AI agents, a respective declaration of the set of declarations for execution and receive, from each of the set of AI agents, data corresponding to the respective declarations. The set of one or more processing devices is further to generate, based on the received data, feedback corresponding to the workflow and provide, for presentation via a user interface of the experience automation platform, the generated feedback corresponding to the workflow

In one aspect, a method includes identifying a workflow corresponding to a user request and determining a set of declarations corresponding to the workflow, where each of the declarations is associated with an artificial intelligence (AI) agent of multiple AI agents. The method further includes identifying a set of AI agents, where each AI agent in the set is associated with a declaration of the set of declarations and assigning, to each of the set of AI agents, a respective declaration of the set of declarations for execution. The method further includes receiving, from each of the set of AI agents, data corresponding to the respective declarations and generating, based on the received data, feedback corresponding to the workflow. The method further includes providing, for presentation via a user interface of the experience automation platform, the generated feedback corresponding to the workflow.

In essence a system for agentic experience automation is described, comprising a MAS, AI agents with reasoning capabilities, and a declaration instruction format for dynamic workflow execution. The MAS dynamically interprets the declarations to determine execution flow and select appropriate agents. The system comprises a fine-tuned language model providing reasoning support to AI agents during execution.

The AI Agents comprise modular capabilities, including classification, extraction, integration and vertical-specific tasks. The AI Agents are configurable with a personal profile including tone, formality, empathy, proactivity etc.

The MAS coordinates with an existing micro-engagement engine for operations. The system is extensible via future plug-in modules and policies without core platform modifications.

The AI Agents can dynamically choose workflows from a service group based on user goals.

Context data is logged, updated, and used in real-time to inform agent decisions and provide auditability.

The system supports deployment across industry verticals including healthcare, insurance, and financial services.

### BRIEF DESCRIPTION OF THE DRAWINGS

The present disclosure will be understood more fully from the detailed description given below and from the accompanying drawings of various embodiments of the disclosure.

FIG. 1 illustrates a generic Customer Experience Automation (CXA) reference architecture using a micro-engagement platform, according to an embodiment of the present disclosure.

FIG. 2 illustrates a layered architecture using the micro-engagement engine that is incorporated into a generative CXA platform, according to an embodiment of the present disclosure.

FIG. 3 illustrates an example of integrating a Multi-Agent System (MAS) for Agentic Experience Automation (AXA), according to an embodiment of the present disclosure.

FIG. 4 illustrates a block diagram of the core structure of the MAS, according to an embodiment of the present disclosure.

FIG. 5 illustrates the functional blocks of an AXA platform, according to an embodiment of the present disclosure.

FIG. 6 illustrates the vendor language model that is the foundation of the generative and agentic experience automation, according to an embodiment of the present disclosure.

FIG. 7A shows the agentic mode, enabling autonomous workflow creation and execution in AXA, in accordance with some embodiments of the present disclosure.

FIG. 7B illustrates the coexistence of traditional micro-engagements and agentic execution in AXA, in accordance with some embodiments of the present disclosure.

FIG. 8 illustrates an AI Agent studio provided by the vendor for Agent management and discovery, in accordance with some embodiments of the present disclosure.

FIG. 9A illustrates the first step in an interface for creating compliant, industry-specific AI agents, in accordance with some embodiments of the present disclosure.

FIG. 9B illustrates persona selection and customization as the second step of creating the AI agent in the given interface, in accordance with some embodiments of the present disclosure.

FIG. 9C illustrates capability assignment and configuration as the third step of creating the AI agent in the given interface, in accordance with some embodiments of the present disclosure.

FIG. 9D illustrates assigning and initially configuring knowledge bases as the fourth step of creating the AI agent in the given interface, in accordance with some embodiments of the present disclosure.

FIG. 9E illustrates finalization and advanced configuration as the fifth step of creating the AI agent in the given interface, in accordance with some embodiments of the present disclosure.

FIG. 9F illustrates persona customization interface, in accordance with some embodiments of the present disclosure.

FIG. 9G illustrates AI Agent dashboard for comprehensive agent management and monitoring, in accordance with some embodiments of the present disclosure.

FIG. 9H illustrates AI Agent training including knowledge skill development and retrieval-augmented generation (RAG) integration, in accordance with some embodiments of the present disclosure.

FIG. 9I illustrates AI Agent capabilities dashboard giving a comprehensive overview of skills, integrations and tasks, in accordance with some embodiments of the present disclosure.

FIG. 9J illustrates extraction skill configuration and training of an AI agent, in accordance with some embodiments of the present disclosure.

FIG. 9K illustrates classification skill configuration and training for email triaging of an AI agent, in accordance with some embodiments of the present disclosure.

FIG. 9L illustrates AI Agent workflow assignment dashboard for managing and monitoring workflow integration, in accordance with some embodiments of the present disclosure.

FIG. 9M illustrates AI Agent smart builder for conversational task creation and agentic execution, in accordance with some embodiments of the present disclosure.

FIG. 9N illustrates AI Agent task execution dashboard for building, simulating and agentic execution of tasks, in accordance with some embodiments of the present disclosure.

FIG. 9P illustrates AI Agent channel configuration dashboard for multi-channel engagement setup and customization, in accordance with some embodiments of the present disclosure.

FIG. 10 illustrates a visual representation of how a multi-agent system (MAS) operates within the AXA platform, in accordance with some embodiments of the present disclosure.

FIG. 11 illustrates a more generic and simpler rendering of the MAS functions shown in FIG. 10 (excluding some proprietary terms), in accordance with some embodiments of the present disclosure.

FIG. 12 illustrates AI Agents and attributes, specifically extensible architecture for agentic notion, in accordance with some embodiments of the present disclosure.

FIG. 13A illustrates functional architecture of an AI agent, in accordance with some embodiments of the present disclosure.

FIG. 13B illustrates structure of an AI agent, in accordance with some embodiments of the present disclosure.

FIG. 13C illustrates lifecycle of an AI agent, in accordance with some embodiments of the present disclosure.

FIG. 14 illustrates an AI Agent framework for execution within the conversational engine of the AXA platform, in accordance with some embodiments of the present disclosure.

FIG. 15 illustrates how traditional Micro-engagement engine is unified with agentic notions, in accordance with some embodiments of the present disclosure.

FIG. 16 illustrates an example machine of a computer system within which a set of instructions, for causing the machine to perform any one or more of the methodologies discussed herein, can be executed.

### DETAILED DESCRIPTION

Embodiments of the present disclosure empower both enterprise persona and their end-users to create and adaptively execute workflows within the enterprise automatically using a Multi-Agent System (MAS) powered by AI Agents. The disclosed systems and methods not only allow for creation and deployment of consumer (end-user) experiences via automation but also enables the consumer experience to be created and executed dynamically (at runtime) with the help of AI Agents within an enterprise's environment.

The AI Agents are sometimes referred to as “Vertical AI Agents,” to indicate that they are tailored for a specific industry vertical (e.g., a business sector). Each agent encapsulates workflows, tasks, and compliance protocols unique to its vertical. For example: in insurance, agents manage workflows for claims processing, policy management, and fraud detection. In healthcare, agents handle patient data management, appointment scheduling, and medical billing, ensuring HIPAA compliance. In financial services, agents facilitate KYC (Know Your Customer) processes, loan applications, and regulatory reporting under GDPR and PCI DSS guidelines.

Security and compliance are inherent to the AI Agent architecture. The Vertical AI Agents incorporate data encryption and authentication protocols tailored to industry standards, performs automated compliance checks that ensure workflows meet regulatory requirements in real-time, and creates audit trails for transparency and regulatory reporting.

Note that the word “customer” encompasses various entities in this disclosure. A business entity (referred to as a “business enterprise” or simply an “enterprise”) can be a customer for another business entity that provides an “Agentic Experience Automation” (AXA) platform, and/or its predecessor, “Customer Experience Automation” (CXA) platform. Though AXA is a term protected by trademark, we have used the term AXA to describe a system that executes agentic workflow autonomously. The Applicant of this patent application, Ushur, Inc. is one such entity that provides the CXA and AXA platforms described herein. To differentiate a provider of the CXA and AXA platforms from the business enterprise, in this disclosure we have sometimes used the word “vendor” to indicate the CXA and AXA platform provider (e.g., Ushur, Inc.). On the other hand, the business enterprise, who is the customer of the CXA and AXA platform provider, has the end-users (or consumers) as their customers. An example would be an insurance provider engaging with current or prospective insurance policyholders using Ushur's CXA and AXA platforms. In this example, the insurance provider is the business enterprise that is the vendor Ushur's customer, i.e. Ushur is the vendor providing a service to the business enterprise. At the same time, the end-users who are interacting with the CXA and AXA platforms are customers (current or prospective insurance policyholders) of the insurance provider (the business enterprise).

The AXA platform uses AXA Declarations, a proprietary declarative framework that translates high-level intents into actionable workflows. Unlike traditional process automation tools (e.g., Business Process Model and Notation, BPMN), AXA Declarations allow workflows to be treated as fluid goals. Vertical AI Agents interpret these declarations dynamically, adapting the execution path based on real-time data, user inputs, and industry-specific regulations.

At its core, AXA introduces a Multi-Agent System (MAS) that coordinates a network of Vertical AI Agents to manage, execute, and adapt workflows in real time. These agents are powered by vendor's fine-tuned language model trained on vendor's proprietary knowledge, industry best practices, and domain-specific data, ensuring that the system aligns with enterprise goals, compliance requirements, and user expectations and/or intent.

The MAS serves as the execution engine of AXA. A MAS comprises, among other components, a core controller that orchestrates workflow execution across agents, a task scheduler that dynamically assigns tasks based on agent specialization and system load, and a task executor, that executes tasks autonomously, leveraging real-time reasoning powered by the vendor's language model.

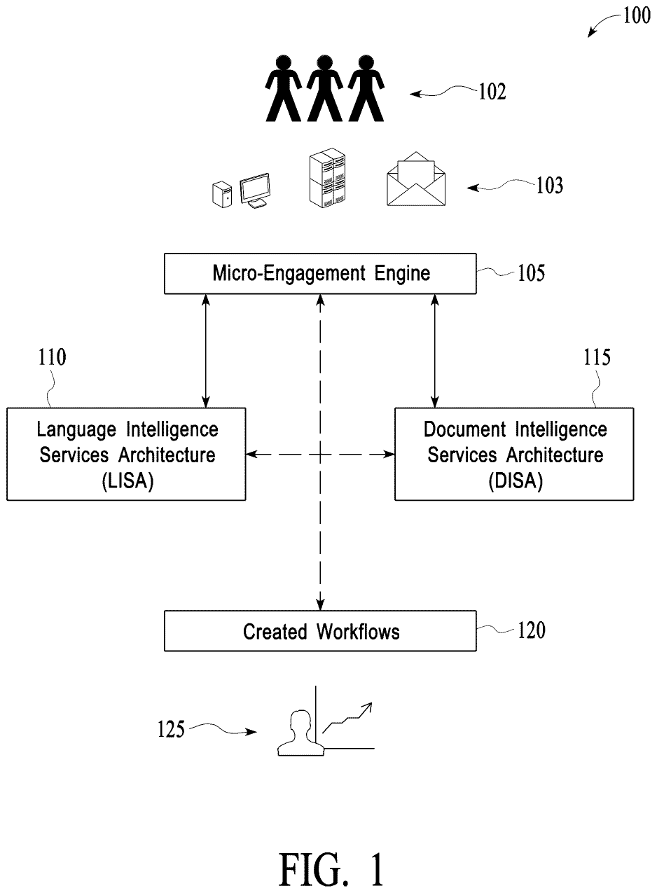

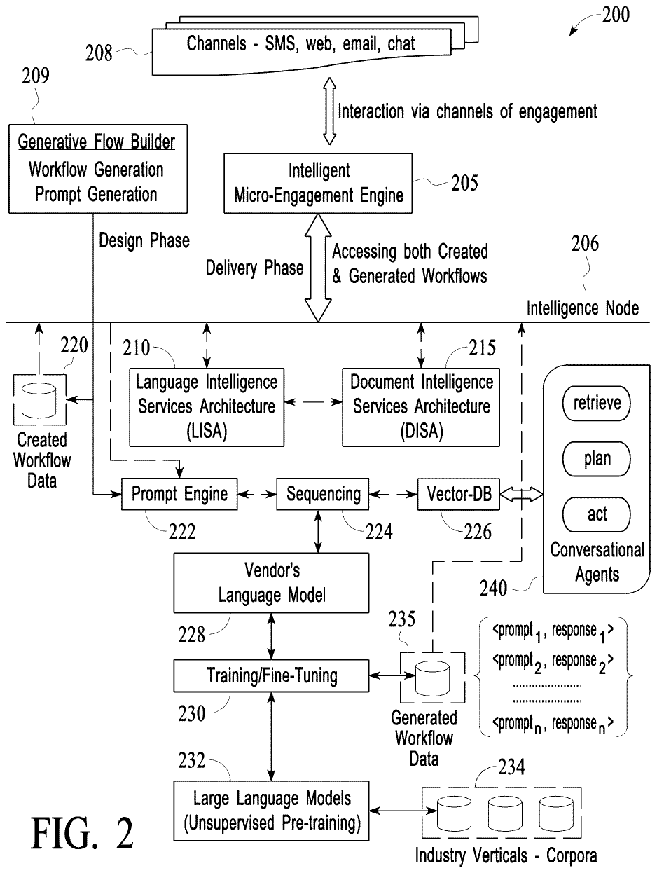

Conventionally, the workflow automation systems are reliant only on the enterprise side to create a workflow. The GenCXA patent application truly shifted the paradigm by allowing the end-users to participate meaningfully in workflow automation within the enterprise, that too without having to code. This dramatic paradigm shift enables end-users to receive a truly personalized service from the enterprise, and the paradigm shift is made possible by Generative Artificial Intelligence (Generative AI). Before describing the AXA architecture, which is the core of this disclosure, we describe a generic CXA architecture in FIG. 1 and a CXA platform enhanced by Generative AI in FIG. 2.

FIG. 1 illustrates a generic Customer Experience Automation (CXA) reference architecture 100 using a micro-engagement platform, which was disclosed in the prior patent application Ser. No. 18/889,015 on Generative CXA. A micro-engagement engine 105 provides end-users 102 various modes of communication 103 (e.g., email, chat or link on a web browser on a desktop/laptop of mobile device or office server, text messages on mobile devices, voice calls etc.) to engage with an enterprise persona. The micro-engagement engine 105 relies on a Language Intelligence Service Architecture (LISA) 110 for natural language processing to extract relevant information from the end-user's textual input. The micro-engagement engine 105 may also rely on Document Intelligence Services Architecture (DISA) 115 for intelligent document processing to extract information from documents provided by the end-user or documents which the end-users filled out (such as a form). Workflows 120 can be created based on the automatically gleaned information from the end-user. An enterprise representative 125 (which can be a virtual person or a real person) is enabled to create workflows or act on the created workflow. In the generic architecture shown in FIG. 1, actual information provided by the end-user is used by an enterprise personnel to create workflows, but the end-user's intent is usually not fully utilized to generate workflows. The enterprise representative 125 engages through the CXA platform's goal builder (that requires no coding, hence called no-code builder). The information provided by the end-user goes to a data warehouse to get analyzed and summarized to figure out services that do not yet exist (missed services). These are the personalized services that the end-users need but have not yet been created by the enterprise persona.

As mentioned above, with Generative AI, the end-users themselves are empowered to create workflow dynamically, such that the workflow is even more aligned with the end-user's expressed intent. Generative AI is powered by very large machine learning models that are pre-trained on vast amounts of data, commonly referred to as foundation models (FMs). A subset of FMs, called large language models (LLMs), are trained on trillions of words across many natural-language tasks. The LLMs can be trained to emit customized content based on the input. The better the quality of the input, the better the generated content. The input instructions fed to a generative AI model are aptly called prompts. The art of crafting the most suitable prompt leads to prompt engineering. Prompt engineering is a rising important discipline that involves crafting the most suitable prompts to result in precise outputs. Note that in the description sometimes the word UshurLLM is used, which in the figures are shown as “vendor's language model,” the specific vendor here being Ushur, Inc. Persons skilled in the art would appreciate that the scope of the disclosure is not limited to the proprietary UshurLLM, and can be customized by other vendors too.

The use of domain-specific Large Language Models (LLMs) fine-tuned for enterprise applications is becoming an industry standard, allowing organizations to develop AI models tailored to their specific business needs. Ushur, Inc. has adopted this approach with UshurLLM, a fine-tuned LLM designed exclusively to govern and optimize automation logic within Ushur's experience automation platform.

While the concept of fine-tuned LLMs is not unique, what differentiates UshurLLM is the proprietary knowledge, automation best practices, and enterprise intelligence that power it. UshurLLM is trained using industry-standard fine-tuning techniques, incorporating: Ushur's best practices in experience automation, ensuring workflows adhere to proven engagement strategies, proprietary automation principles, embedding enterprise-grade decision-making, compliance, and efficiency optimizations, and domain-specific expertise, focusing on intelligent workflow execution, micro-engagements, and adaptive customer experience automation.

UshurLLM is not a general-purpose model, but rather a CXA-specific intelligence layer designed to influence all automation logic within Ushur's platform. While customer-specific LLMs can be fine-tuned separately for unique enterprise requirements, UshurLLM serves as the foundation that ensures all automation aligns with Ushur's CXA framework.

UshurLLM operates within a cluster of LLMs (xLMs), where different models specialize in distinct automation functions, industries, or customer-specific applications. However, UshurLLM remains the central guiding intelligence, ensuring a consistent, adaptive, and enterprise-ready AI-driven experience automation platform.

While fine-tuned LLMs will become the norm for automation platforms, what is proprietary to Ushur is the specific information, methodologies, and automation strategies infused into UshurLLM's training. This proprietary tuning process represents Ushur's competitive advantage, allowing for a highly optimized, self-improving AI-driven automation system.

In summary, the vendors language model, e.g., UshurLLM serves as the foundational language model, fine-tuned with platform-specific knowledge and industry best practices. While fine-tuned models are becoming standard, UshurLLM is unique in that it not only guides workflow generation but also drives real-time agentic decision-making during execution. It embeds industry-specific regulatory requirements (e.g., HIPAA for healthcare, GDPR for financial services), ensuring that agents operate within compliant frameworks.

The prior patent application on Generative CXA described novel systems and methods that can bring in this new paradigm of generating workflows automatically through a mere intent of a participant expressed in a description at a given visual interface, whether they are from the enterprise or from end-users served by the enterprise. The enterprise representative 125 engages through the CXA platform's no-code builder component to create workflows and/or act on generated workflows, as described below.

FIG. 2 illustrates a layered architecture 200 using the micro-engagement engine that is incorporated into a CXA platform which is enhanced with a ‘generative’ aspect to capture and capitalize the user's intent better for end-to-end intelligent automation purposes, according to an embodiment of the present disclosure. The architecture 200 was also disclosed in the prior patent application Ser. No. 18/889,015 on Generative CXA. The architecture 200 is an improvement over the architecture 100 shown in FIG. 1, as architecture 200 leverages prompt engineering to automatically ‘generate’ workflows in addition to ‘creating’ workflows by the enterprise persona. The prompts created by the enterprise or the end-users can be weaved in related examples that match the descriptions and the system can arrange the prompt pipeline to instruct the LLMs to generate an apt workflow schema.

The LLMs are capable of being taught via plain language on what to generate given the input description. The CXA platform (or any automation platform) can generate specific programming code (e.g., JSON elements) based on the input instructions. Examples of input and output JSON are illustrated further below in this patent application. The output JSON elements represent a simplified workflow specification that can be fed into the micro-engagement engine for execution.

In some embodiments, the instruction-tuned LLM can be created from foundational LLMs through supervised learning. One such example of supervised learning is a technique called Reinforcement Learning with Human Feedback (RLHF) where the model gets feedback from a human for each given instruction.

In the layered architecture 200 shown in FIG. 2, the intelligent micro-engagement engine 205 sits on top of an intelligence node 206 at the back-end to be able to deliver hyper-automation based on not only workflows that are created by enterprise persona, but also based on workflows that are ‘generated’ by using artificial intelligence (AI) and machine-learning (ML). The CXA platform provides a dynamic user interface at the front-end for serving a multi-persona dialog-based interaction between the end-user and one or more enterprise persona. In short, the Intelligent micro-engagement engine 205 can access both created workflow data 220 and generated workflow data 235 to enhance customer experience. The micro-engagement engine 205 engages with the end-users via various channels of engagement 208, such as text (e.g., SMS), web browser, email, chat etc.

The key tenet of the CXA platform is to leverage AI/ML throughout the CXA platform to elevate customer experience. Generative aspects of AI and LLMs are employed at multiple layers within the platform.

The first layer is in “Generative Flow Builder” 209. The generative flow builder acts during the design phase of the CXA platform to generate pre-created workflow modules. The generative flow builder 209 leverages generative models for prompt generation within a workflow and to generate the workflow itself. The generative flow builder 209 utilizes generative models, such as Large Language Models (LLMs) 232, for both prompt generation within a workflow and for the creation of the workflow itself.

Prompt Generation, in the context of Generative Flow Builder 209, refers to the capability of the builder interface to engage with the citizen developer (the individual who assembles various modules into a workflow using drag-and-drop functionality) in a multi-turn conversational format. This interaction allows for the customization of the output's tonality, verbosity, and style according to the specific requirements of the business use case, with the generative AI optimizing the module prompts accordingly. A citizen developer is a business user within the enterprise who creates software applications without extensive coding knowledge, usually using low-code or no-code tools.

Workflow Generation, in the context of Generative Flow Builder 209, involves a smart chat widget that interacts with the end-user or citizen developer in a multi-turn conversational manner to collect information, define guidelines, and determine the purpose of the workflow. The chat widget then automatically selects the appropriate modules and their attributes, integrates them, and produces a complete workflow ready for use by the end-user. This process is powered by Large Language Models and advanced prompt engineering techniques.

The second layer comprises the “Conversational Engine.” The conversational engine may be part of the Language Intelligence Service Architecture (LISA) 210. The conversational engine runs the conversational agents. Autonomous conversational agents 240 engage with end-users by various frameworks, such as ReAct (Reason and Act) or MRKL (Modular Reasoning Knowledge and Language) frameworks. These frameworks enable the conversational agents to retrieve information (e.g., from external APIs), and use natural language reasoning to plan and act on the retrieved information. This second layer coordinates with micro-engagement engine at one end and participates in multi-turn dialog with end-users to reach specified end-goals by enabling LLMs to perform certain actions.

The third layer has the Document Intelligence Services Architecture (DISA) for intelligent extraction of information from documents. Foundational LLMs 232 and/or fine-tuned domain-specific LLMs (228, 230) are leveraged for extracting relevant values for key business entities from unstructured documents and converting them into structured forms for downstream processing.

The second and third layers are employed during the delivery phase of the workflow automation, while, as mentioned above, the first layer of generative flow building is employed during design phase. The first layer of generative flow building is utilized by enterprise persona (e.g., 125), while the second and third layers are utilized by the end-users.

The efficacy of the Generative AI depends a lot on LLM training. One of the major goals in the present patent application is to tune a LLM to understand the end-user intent and to generate the right workflow JSON based on end-user intent. There are various ways of training the LLM with the required fine-tuning that is necessary. The workflow JSON contains a programmatic representation of the personalized service requested by and/or delivered to the end-user.

One example is pretrained foundational LLM with few short customized JSON prompts-this is a quick way to run with in a deployment and can be packaged in a default offering on the cloud. The block 232 shows one such model. The foundational LLMs can be pre-trained by various corpora of data 234 relevant to industry verticals, such as insurance industry, healthcare industry etc.

Another example is pretrained LLM that is “instruction fine-tuned” with various workflow JSONs. The block 230 shows one such model.

A third example is a business enterprise's own LLM trained with domain-specific instruction workflow samples. Number of workflow generation samples may vary, and the number can be in the range of thousands or even more. The business-specific language model block 228 shows one such model, e.g., a language model for the Applicant Ushur, Inc.

The idea is to start with an unsupervised LLM and progressively tune it to become more and more domain-specific based on the enterprise's business need.

The supervised or semi-supervised training of an unsupervised pre-trained LLM determines the efficacy of the workflow ‘generation’. The candidate LLM prompts are first selected from a vector database 226 based on vector distance/similarity and infused further with context from the end-user description before feeding into the LLMs. Then the generated schema goes through a validity checker (not shown) which can attest to the schema's validity. The validated schema then goes through an integrity checker (not shown) that can attest to the error-free full workflow logic that the executing micro-engagement expects and further goes through a deployment checker (not shown) that can run through various checks to ensure that the workflow can be deployed safely. The generated workflow also goes through another visual adapter (not shown) layer that can convert the generated executable schema into a more exhaustive presentable schema that subsumes the execution schema parameters.

Once the run-time schema is generated and validated for deployment, the workflow can be scheduled for timely deployment or can be instantly deployed through the micro-engagement engine. The sequencing module 224 determines the scheduling. The prompt engine 222 is coupled to the generative flow builder 209 to enable the enterprise persona and/or the end-users to create effective prompts for creating and/or generating workflow (220, 235). The generated workflow data 235 is based on prompts and corresponding responses (e.g., the pairs indicated as <prompt₁, response₁>, <prompt₂, response₂>, . . . <promptₙ, responseₙ>).

While there are no properly established guidelines on the kind of prompts as this is still a nascent field, an explicit prompt that provides a clear and precise direction is needed. An example of a prompt can be: “Generate a workflow that can initiate a welcome with a greeting to the claim center and present a few options, such as, File a claim, Check status of a claim and Leave a feedback”. These options (e.g., “file a claim”, “check status”) are not themselves hooks, but behind each of these options, the system is trained to use one or more hooks to leverage when each of these options is generated. For example, a hook can be connection to a database. A specific configured webhook calls into enterprise systems. In other words, the underlying actions are the hooks and the system is already trained to leverage the correct underlying module that would use the hooks. Those specific modules are needed for a particular option (e.g., “file a claim.”).

As the system learns higher-level primitives, a context-based prompt can also be supported. An example for context-based prompt would be: “Would like to get some feedback from all claimants based on the last 3 months of claim submission and processing.” For a prompt like this, the system is capable of generating lookups on database which it had been previously trained on and other hooks it can generate to fulfill the specific requirements given in the prompt.

The system at the fundamental level supports prompts like that of code-generation where the prompt can be specific about each steps involved in the workflow that is going to be generated. As an example of a composite prompt consider this: “Please generate an usher that will first do the greeting, then post an open ended response to inquire on what the user is interested in and present services such as Filing a claim, checking the status of a claim as options, and allow the user to navigate among these options and when done with the existing services will be able to get some feedback on the overall experience of this engagement.”

In certain cases, based on user expression and input, multiple workflows may need to be generated. Some newly generated workflows may need to be associated with existing workflows. The multiple workflows may need to be sequenced in a certain order along with conditions. Consider an example like this from an end-user: “check my policy and if it is going to expire soon, send me a renewal link.” For this example, the system is capable of interpreting the end-user's intent properly. Only when the policy is going to expire with a certain predetermined time period to define ‘soon,’ the renewal flow would be generated or kicked-off if renewal has already been sent.

The enterprise persona sets boundaries (or guardrails) on the kind of services an end-user can generate. This ensures that the requested services are within the capabilities and domain of the enterprise. The enterprise persona has the capability to review the end-user generated workflows at a later point. It can decide to approve or reject some services that are outside the domain of the enterprise.

Summarizing what is shown in the prior patent application on generative CXA, the end-user's intent gets translated into simplified JSON elements that can either be immediately fed into the micro-engagement engine for execution or can be fed into a scheduler for future execution.

In the progression of experience automation, the workflow remains the core element, being both constructed and executed through the innovative concept of micro-engagements, as introduced in the original framework. AI capabilities were integrated using two distinct frameworks: LISA for managing conversational text interactions, and DISA for processing documents—whether structured, unstructured, or semi-structured. The AI components were contextually embedded within the appropriate modules of the workflow, ensuring their functionality was applied precisely where and when needed.

While Generative CXA fundamentally transformed workflow creation, workflow execution remained static, following predefined sequences with no real-time adaptability. The underlying Micro-Engagement Engine executed workflows using predefined rules, even though those workflows were dynamically generated using UshurLLM, a model trained on Ushur's proprietary automation principles and best practices.

With advancements in AI-driven agents, autonomous execution, and dynamic decision-making, the need has emerged for a system that not only generates workflows intelligently but also executes them in a self-adaptive, goal-driven manner. This has led to the development of Agentic Experience Automation (AXA).

It is important to note that AXA does not depend on Generative CXA—it is a standalone innovation that can operate independently or, where applicable, subsume Generative CXA as part of a broader agentic automation framework. While Generative CXA addressed workflow generation, AXA focuses on execution, adaptation, and real-time decision-making, ensuring that automation is not just rule-based but truly autonomous. The mention of Generative CXA here provides historical context, illustrating the technological advancements and deployed system needs that have led to the next stage of AI-powered experience automation—one that is agentic, self-learning, and capable of optimizing workflows dynamically without human intervention.

The advent of Large Language Models (LLMs) significantly transformed the technological landscape, prompting frameworks like LISA and DISA to integrate LLMs for more advanced information processing tasks, including classification and data extraction. Pre-trained LLMs, such as OpenAI's GPT-x or Google's Gemini, already possessed the ability to comprehend vast datasets spanning industries like insurance, healthcare, and financial services.

Building on this foundation, the Generative CXA patent application proposed leveraging these generative capabilities not just for data processing but also for workflow generation. This system allowed workflows to be generated either at design time by an enterprise persona or at runtime in response to a user's request—even if the specific service didn't yet exist. The GenCXA system could dynamically generate the necessary workflow and execute the service in real-time. This was made possible by prompt-tuning the underlying LLM with detailed information about the Ushur Platform, its workflows, and modules.

To streamline this process and eliminate the need for repetitive prompt injections into standard pre-trained models, the concept of UshurLLM was introduced. By fine-tuning an open-source LLM with all proprietary knowledge specific to Ushur's platform and automation methodologies, UshurLLM became a tailored model capable of handling workflow generation and data processing natively, without the need for continuous external prompting.

However, it's important to note that while Generative CXA revolutionized workflow creation, the execution of those workflows still relied on the Micro-Engagement Engine, which remained largely rule-based and predefined during execution.

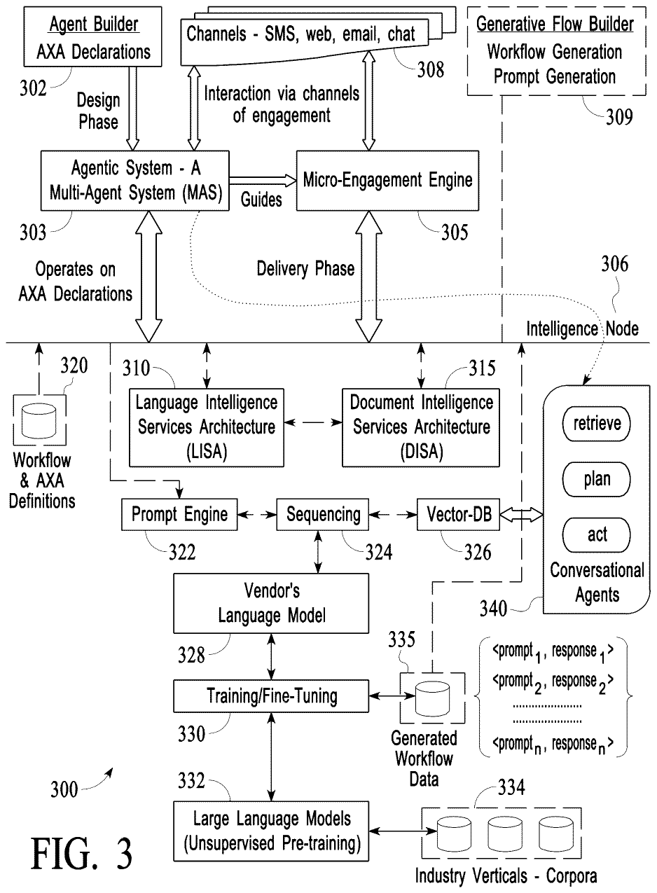

FIG. 3 illustrates a layered architecture 300 using the micro-engagement engine for agentic experience automation, which is the core of the current disclosure. It is essential to emphasize that Agentic Experience Automation (AXA) represents an independent evolution in the field of experience automation. While Generative CXA introduced the ability to dynamically generate workflows using LLMs, AXA operates as a standalone innovation that focuses on autonomous execution, real-time adaptation, and intelligent decision-making. AXA can function entirely independently or, when beneficial, integrate Generative CXA within its broader agentic automation framework.

Whereas Generative CXA addressed the creation of workflows, AXA advances the field by revolutionizing how workflows are executed. It transitions from static, rule-based automation to systems that are self-governing, context-aware, and capable of dynamically adjusting their actions based on evolving data and user interactions. The reference to Generative CXA in this context serves to highlight the technological progression and the evolving system needs that have driven the development of AXA.

Ultimately, AXA represents the next phase of AI-powered experience automation —a system that is not only capable of generating workflows but is also agentic, self-learning, and designed to optimize workflow execution autonomously, without the need for human intervention. AXA is designed to be industry-agnostic at its core but becomes industry-specific in its deployment. By incorporating verticalized functions, tasks, and compliance mechanisms, AXA enables Vertical AI Agents tailored to industries such as insurance, healthcare, and financial services. These agents are designed to dynamically adapt workflows, integrate regulatory requirements, and deliver personalized user experiences, marking a significant advancement in the field of autonomous experience automation.

Note that many of the components in architecture 200 (FIG. 2) and architecture 300 (FIG. 3) are similar and they have been shown with similar numbering in FIGS. 2 and 3. For example, components 305, 308, 309, 306, 310, 315, 322, 324, 326, 340, 328, 330, 332, 335, 334, 340 are similar to 205, 208, 209, 206, 210, 215, 222, 224, 226, 240, 228, 230, 232, 235, 234, 240 in FIG. 2, with the necessary alteration needed for integration AXA functions. For example, created workflow data 320 in FIG. 3 also includes AXA definitions. And the architecture in FIG. 3 has specific components, such as Agent builder 302 and an agentic system 303. The agentic system 303 can be a multi-agent system (MAS). The agentic system 303 is engaged with the end-users via communication channels of engagement 308.

A Multi-Agent System (MAS) 303 that brings agentic behavior is at the core of the Experience Automation Platform—whether it's the original CXA platform or the more advanced Generative CXA platform. While MAS architectures have existed in various domains, the system proposed here is novel and specifically tailored for experience automation.

In this architecture, a collection of core AI agents within the MAS collaborate to manage and optimize the automation process, as described below.

The MAS operates based on defined constructs known as AXA Declarations, which instruct the system on what tasks to execute, when to execute them, and with what parameters.

Unlike earlier models where the Micro-Engagement Engine controlled execution, the MAS now guides micro-engagements only when necessary, shifting the control to a more dynamic, agent-driven execution model.

The MAS leverages AXA Declarations to determine when to engage additional tools, APIs, or external services, adapting in real-time based on the task at hand.

Communication agents within the MAS manage interactions over established channels, collaborating with conversational agents that utilize LLMs to engage users across multiple touchpoints—both for incoming requests and outgoing responses.

Workflows are transformed into AXA Declarations, allowing them to be “agentified” executed autonomously by the MAS rather than through static, rule-based processes.

Even generated workflows from Generative CXA can be agentified in their execution, meaning that while GenCXA continues to offer the same dynamic workflow creation capabilities, their execution is now handled by the MAS for more adaptive, intelligent outcomes.

While Generative CXA remains a valuable component, it is not a prerequisite for AXA. The MAS introduces a new layer of autonomy and intelligence to experience automation, enabling workflows—whether generated or predefined—to be executed dynamically and optimized in real-time.

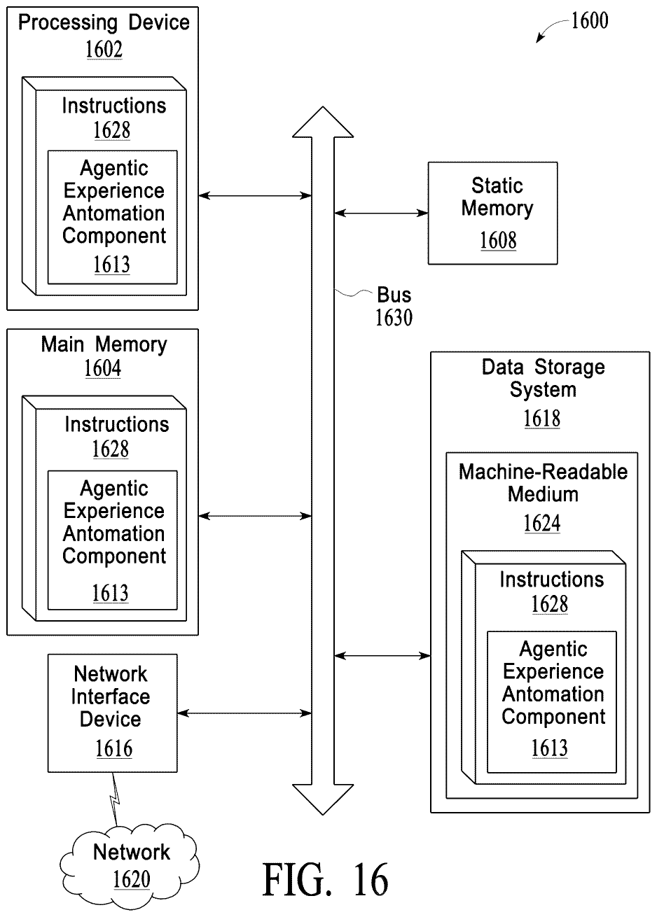

In general, the various building blocks of the architecture 300 are part of an agentic experience automation component 1613 in a computer system, as described further below with reference to FIG. 16.

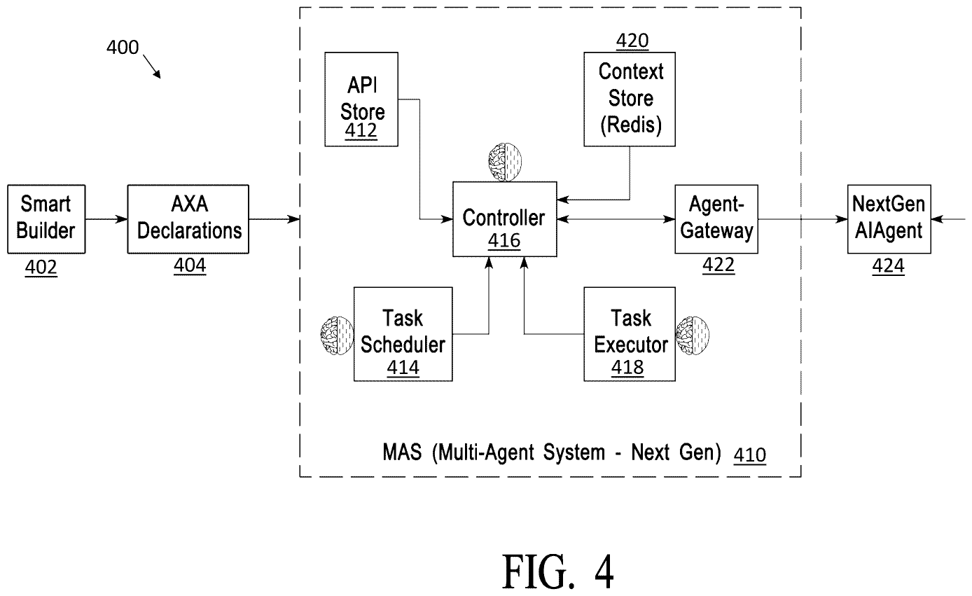

FIG. 4 illustrates the architecture 400 structure of a Multi-Agent System (MAS) 410. The disclosed Multi-Agent System (MAS) 410, in its foundational design, comprises several key components: a Core Controller 416, Task Scheduler 414, Task Executor 418, API Store 412, and Context Store 420. It also facilitates communication with other agents through a gateway interface 422.

The Core Controller 416, Task Scheduler 414, and Task Executor 418 are all powered by LLMs, enabling them to reason and adapt to various situations dynamically. The MAS 410 is activated through AXA Declarations 404, a specialized language that the system interprets to determine tasks and workflows. The AXA declarations 404 can be provided by a smart builder 402, such as agent builder 302 shown in FIG. 3.

In some embodiments, AXA Declarations 404 are produced by AI Agent constructs originating from the Agent Studio (whose features are described further below), which functions as an Agent Factory for creating and configuring agents. From this perspective, the MAS Task Executor 418 is responsible for executing each AI Agent within the system, ensuring that tasks are carried out autonomously and intelligently across the experience automation platform.

The AXA Declaration 404 serves as the instructional language that guides AI Agents in executing tasks autonomously. This declarative framework outlines the intent, associated dependencies, and the logical flow required to complete a given task. The structure ensures that agents can interpret, plan, and execute workflows dynamically, adapting to real-time conditions and contextual requirements. In some embodiments, an AI agent can make real-time adjustments to the workflow, such as: updating an execution time of one or more operations (e.g., rescheduling a task for a later time or expediting execution based on priority), adding one or more additional operations, removing one or more operations, or updating one or more workflow parameters.

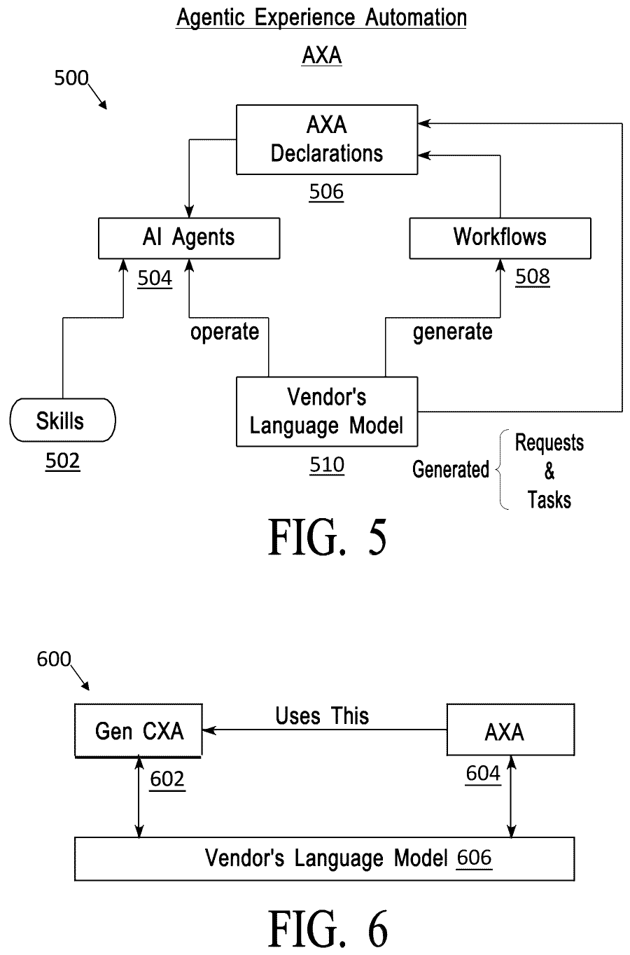

FIG. 5 shows that at the core of Agentic Experience Automation (AXA) 500 is the vendor's language model 510 (e.g., UshurLLM), a domain-specific language model that serves as the foundational AI substrate for the platform. Sometimes the vendor's language model 510 is described as vendorLLM. And in the specification, the illustrative example of UshurLLM can be customized for any vendor. VendorLLM is fine-tuned with comprehensive knowledge of Vendor's primitives, functions, modules, workflow structures, best practices, and feature sets within the product ecosystem. This model empowers AI Agents 504 by guiding their agentic behaviors, enabling them to not only generate workflows 508 for both enterprise users and end-users, but also to reason and make decisions aligned with Vendor's experience automation principles.

VendorLLM functions as the in-house consulting model for all AI-driven reasoning across the application layers, particularly in systems involving AI Agents 504. Any application within the platform that requires contextual decision-making or automation guidance will leverage VendorLLM to ensure consistency with Vendor's standards and best practices.

The AXA Declaration 506 serves as the instructional language for AI Agents, providing the necessary directives to understand, interpret, and act upon workflows 508. These agents are equipped with a variety of specialized skills 502, including text classification, information extraction, and knowledge base comprehension, allowing them to operate autonomously while executing complex tasks within the automation framework.

FIG. 6 shows that the Vendor's language model 606 serves as the foundational model that supports both the previously proposed Generative CXA 602 and the newly introduced Agentic Experience Automation (AXA) 604. While AXA 604 operates independently of Generative CXA 602, it can seamlessly leverage Generative CXA's capabilities to dynamically generate workflows and execute them within the AXA environment, ensuring autonomous, adaptive workflow management.

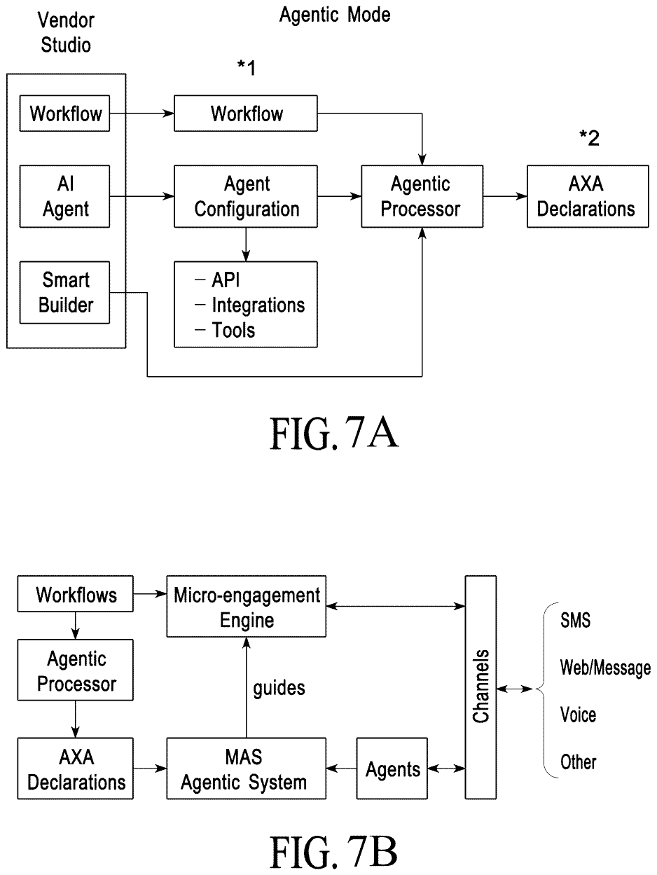

FIG. 7A illustrates the Agentic Mode and the components and processes required to achieve agentic automation within the system. It comprises three core elements within the studio environment: (1) workflow creation-a traditional no-code interface that allows users to manually design and configure workflows; (2) AI agent creation-a module within the studio for building AI agents with specific characteristics and capabilities tailored to enterprise needs; and (3) Smart Builder-a chat-driven interface powered by LLM support on the backend, connected to VendorLLM. This allows users to generate workflows conversationally, streamlining the design process through natural language interactions.

The AI Agent configuration itself involves defining tasks that are structured as workflows. Whether created manually by users or generated through AI, both workflows and AI Agent configurations are processed by the Agentic Processor. This processor converts them into AXA Declarations, the standardized language that AI Agents understand and use to enable agentic execution.

Agentic execution refers to the autonomous execution of workflows and tasks by AI Agents, guided by AXA Declarations. This execution is dynamic and adaptive, allowing agents to handle tasks, APIs, integrations, and other functionalities in real-time, adjusting to the environment as needed. The system ensures that AI Agents can operate independently, making decisions and executing workflows in a flexible, intelligent, and goal-oriented manner.

FIG. 7B illustrates the coexistence of traditional micro-engagements and agentic execution in AXA. In the Agentic Mode, the system demonstrates the simultaneous operation of traditional workflow-based micro-engagement execution alongside AXA Declaration-driven agentic execution powered by the Multi-Agent System (MAS).

While workflows executed by the Micro-Engagement Engine follow a non-agentic, rule-based approach, the MAS orchestrates agentic execution through a network of specialized AI Agents. Both systems can interact with users via channel interfaces, but in the agentic model, the MAS leverages channel-specific AI Agents for more dynamic and intelligent user engagement—though this specialization isn't mandatory.

Furthermore, the MAS can interact with the Micro-Engagement Engine at a granular level, providing guidance and influencing specific parts of the engagement process. In traditional workflows, the Micro-Engagement Engine operates as the sole decision-maker for execution. However, in Agentic Mode, the engine acts under the direction of the MAS, executing tasks only as instructed by the agentic framework.

This dual-mode architecture allows for flexible automation strategies, blending static, rule-based workflows with adaptive, autonomous execution to meet varying enterprise needs.

A key feature of the Multi-Agent System (MAS) within Agentic Experience Automation (AXA) is its ability to dynamically delegate tasks to the Micro-Engagement Engine as needed. The MAS can select specific parts of a workflow to be handled by the micro-engagement engine, instructing it to execute those tasks and then return control to the MAS at the appropriate state for continued agentic execution.

This delegation ensures that the MAS maintains full oversight of the workflow, allowing it to leverage the micro-engagement engine for routine or predefined tasks, while retaining control over more complex, adaptive, or decision-driven processes. The system's ability to seamlessly transition between agentic execution and traditional micro-engagement workflows provides a flexible, hybrid approach to experience automation, optimizing both efficiency and intelligence in task execution.

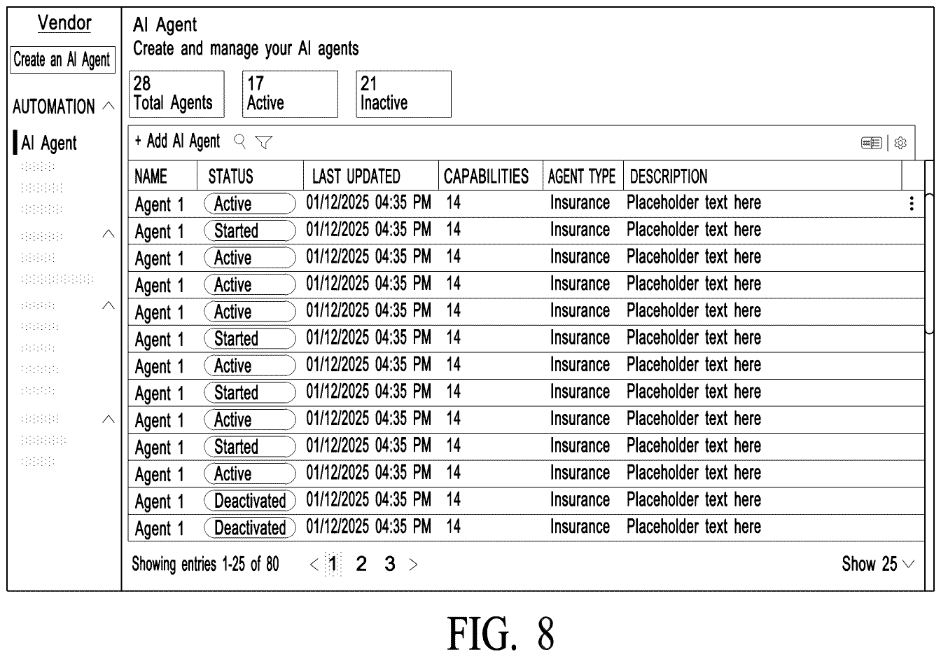

FIG. 8 shows the functionality of an AI Agent Studio. The AI Agent Studio provides a centralized interface where all AI Agents within the AXA platform are listed and managed. This environment allows users to search, filter, and explore the agents based on various criteria, ensuring seamless navigation and configuration.

Some key features of the AI Agent Studio include but are not limited to: comprehensive agent listing, search and filtering options, and agent capabilities display. Comprehensive agent listing refers to displaying all AI Agents currently active or available within the system. Each agent entry includes essential details such as name, type, description, and capabilities. Search and filtering options refers to features that allow users to search for agents using keywords related to their type, description, or assigned capabilities. For example, filter agents can based on specific criteria such as agent type: (e.g., Conversational Agent, Data Extraction Agent, Classification Agent), functionality: (e.g., Customer Support, Email Triage, Workflow Automation), and industry use-case: (e.g., Healthcare, Insurance, Financial Services). Agent capabilities display refers to each agent's capabilities are shown as a detailed list rather than a numerical value. Examples of capabilities can include answering questions using Retrieval-Augmented Generation (RAG), updating customer information (e.g., address changes), downloading and delivering ID cards, processing document-based tasks (e.g., extracting key entities from claims forms), classifying incoming emails for appropriate routing (e.g., customer service triage), integrating with enterprise systems like Salesforce, EMRs, and CRMs.

AI Agent Studio and its agent management capabilities, showcases the flexibility and modularity of the AXA platform. This highlights the agentic nature of the system—where agents can be searched, configured, and assigned tasks dynamically, which is a core differentiator from static automation systems.

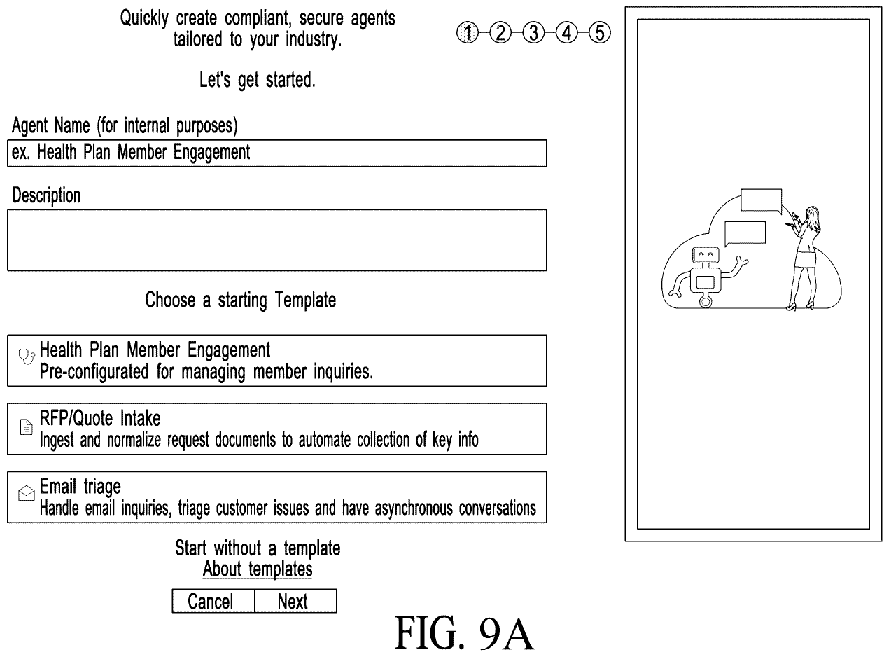

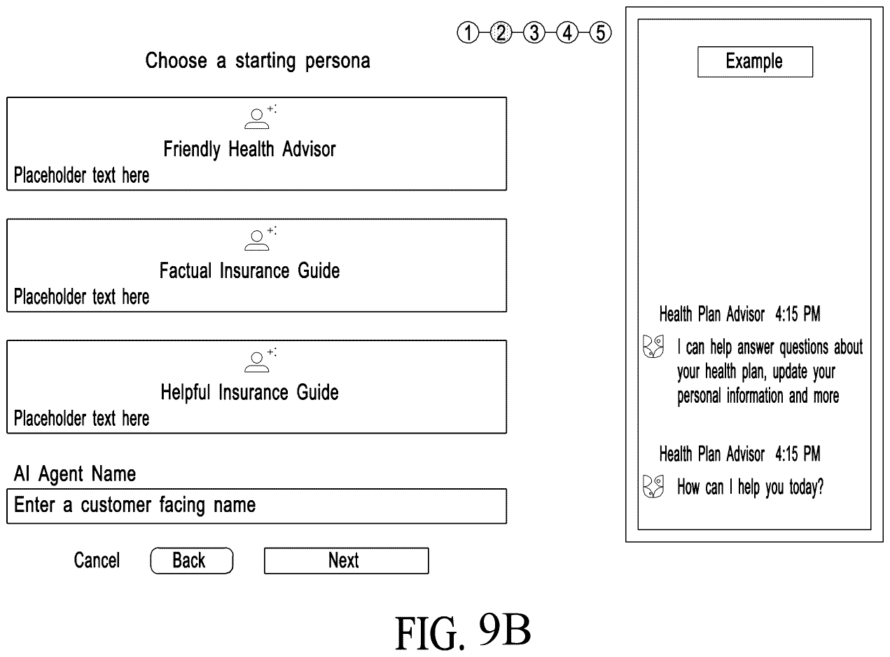

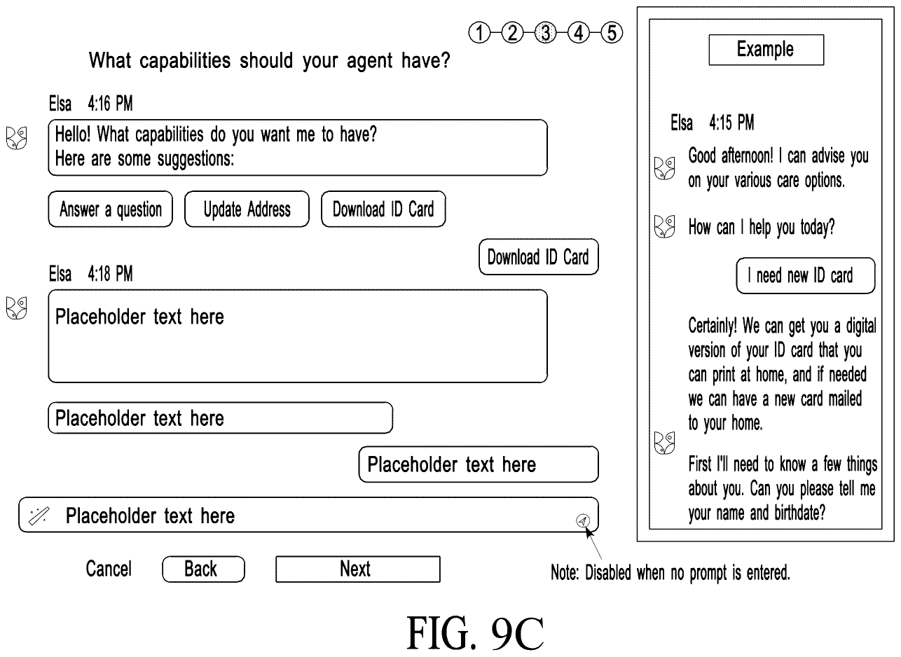

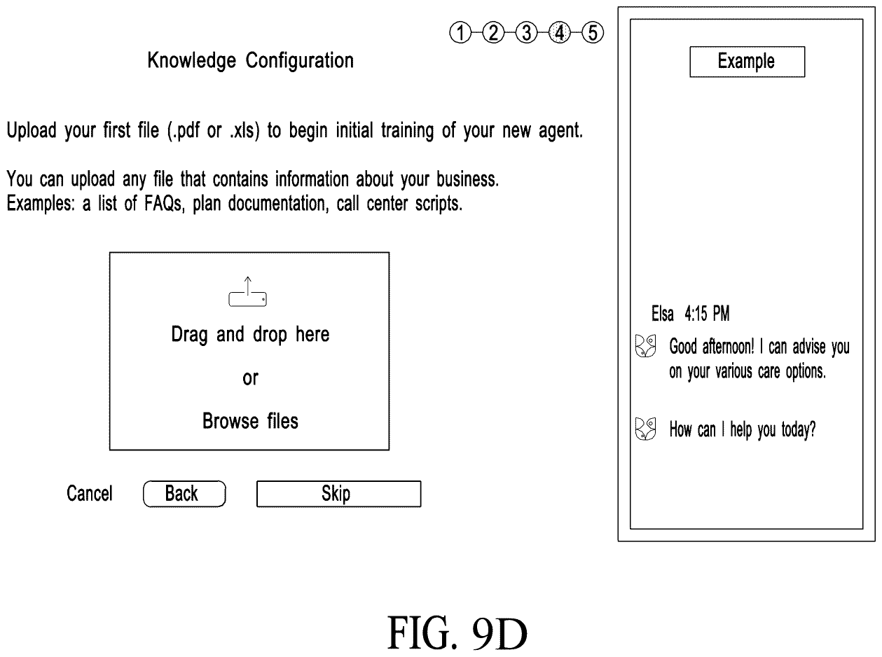

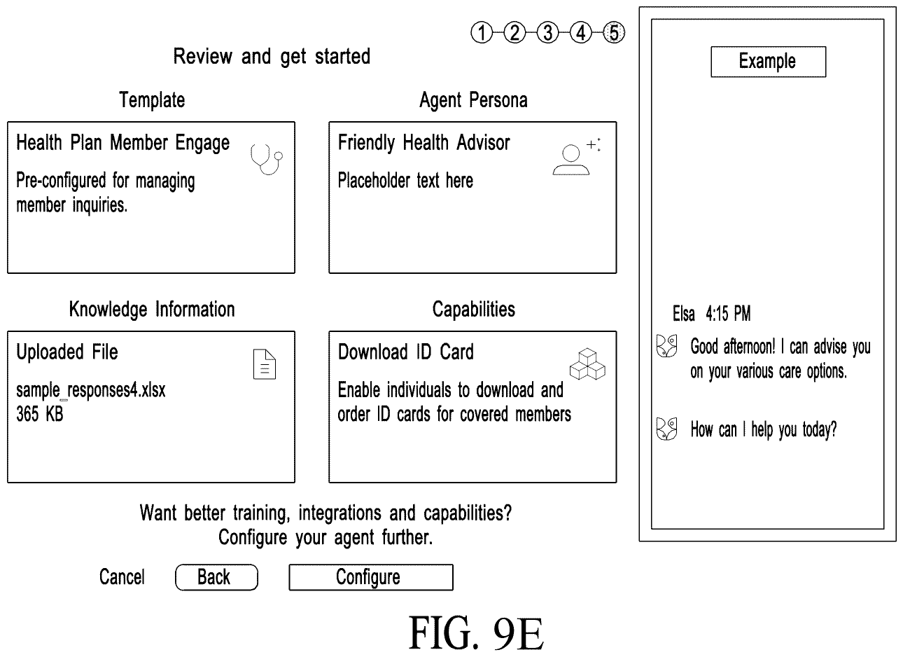

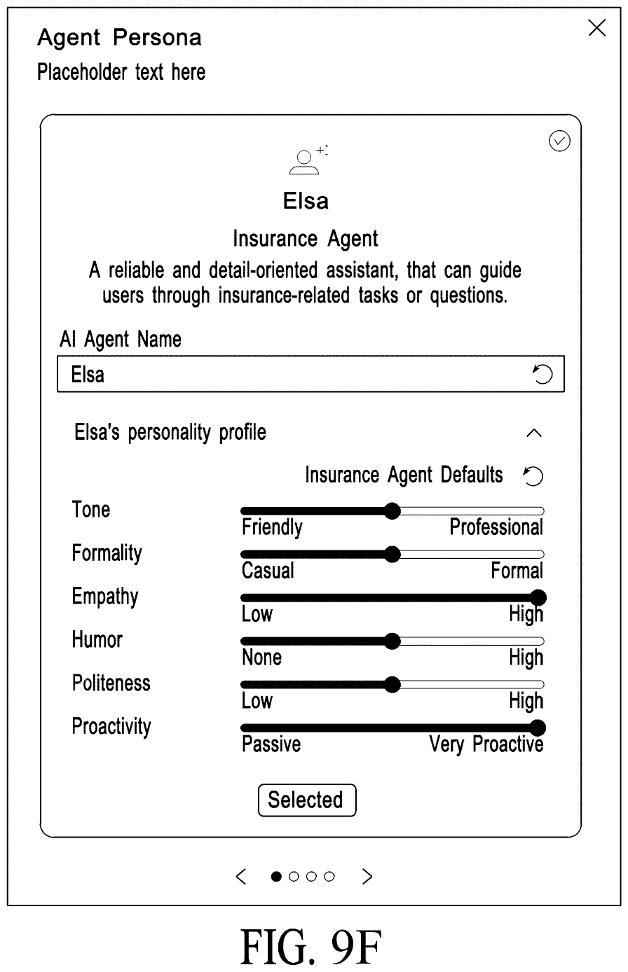

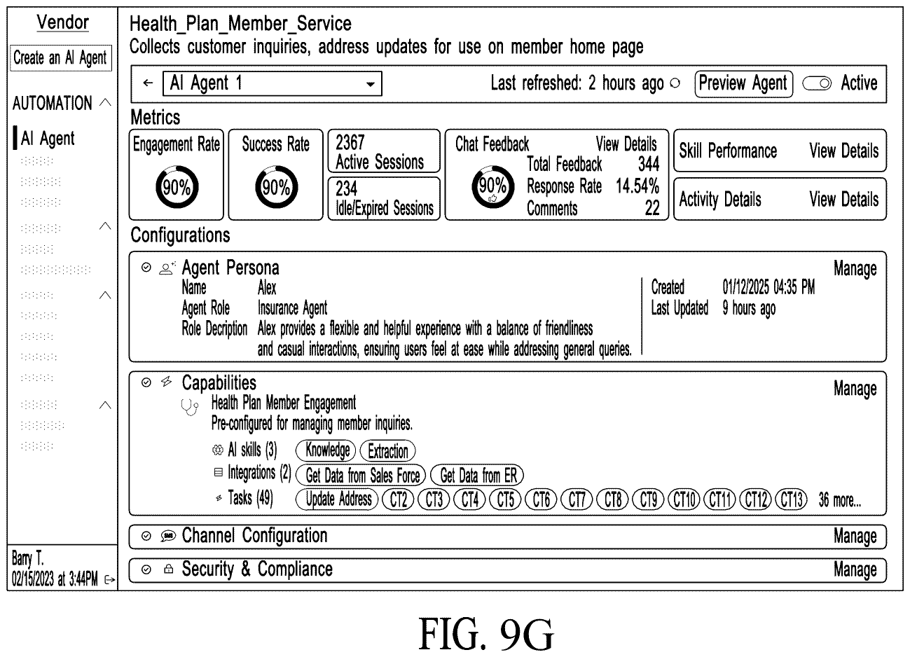

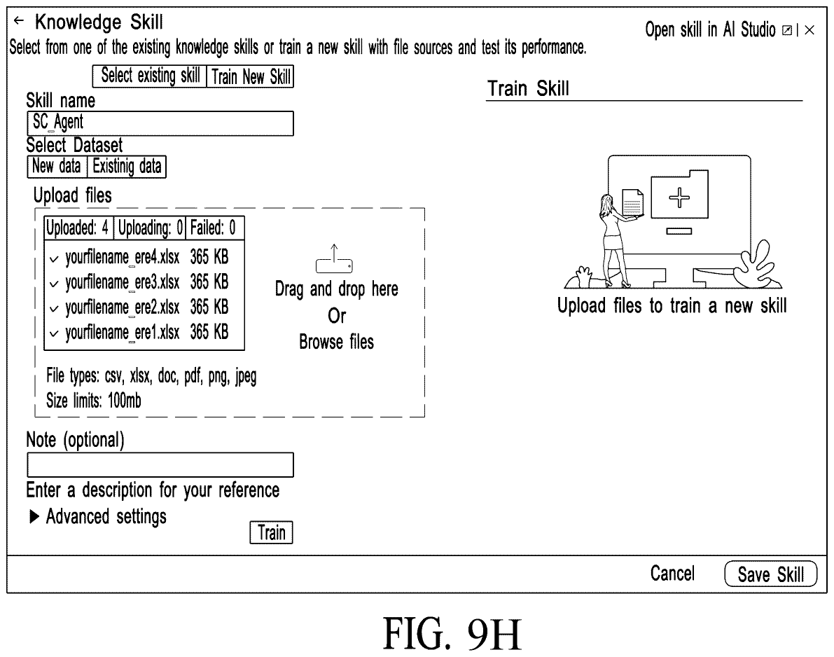

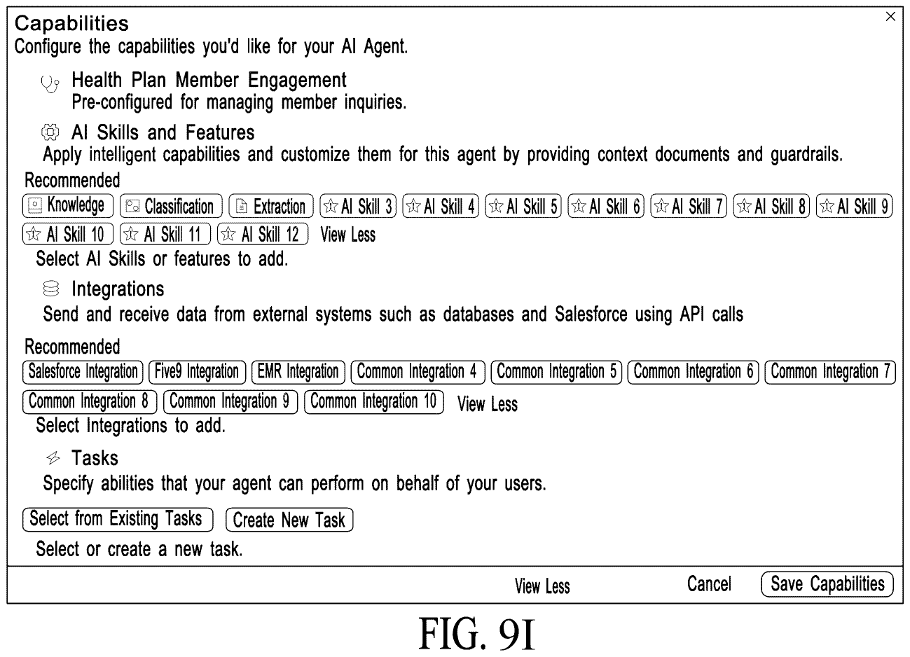

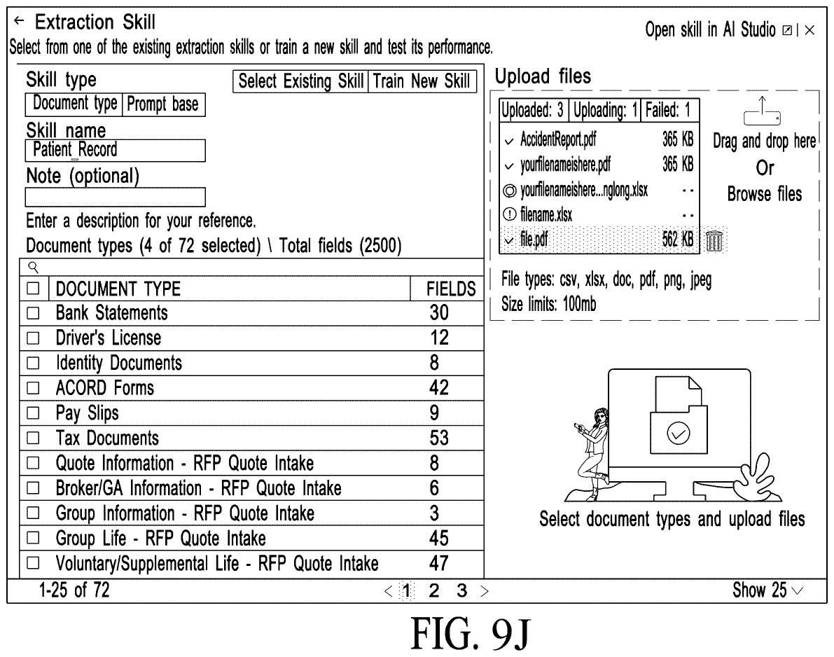

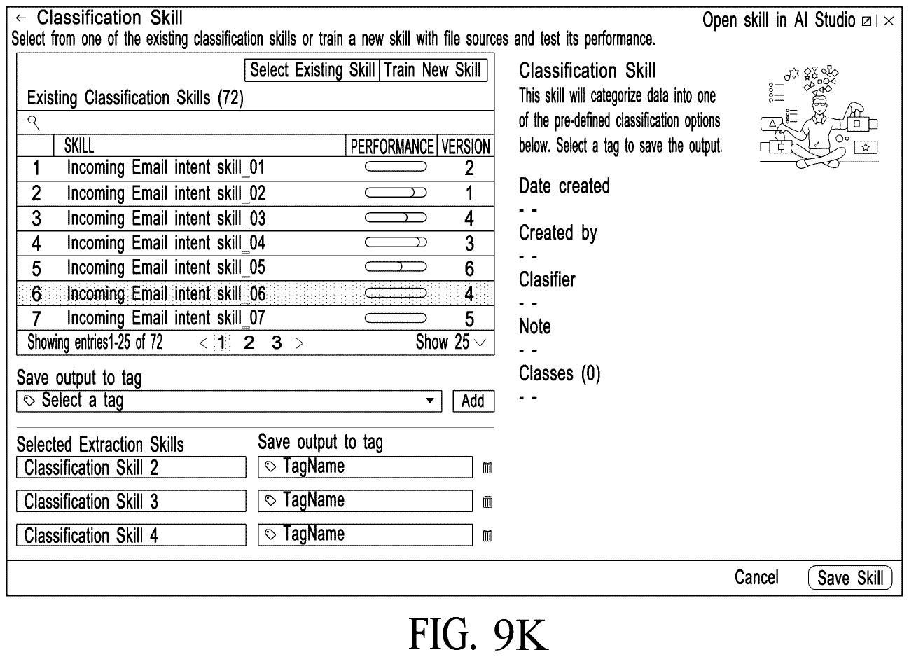

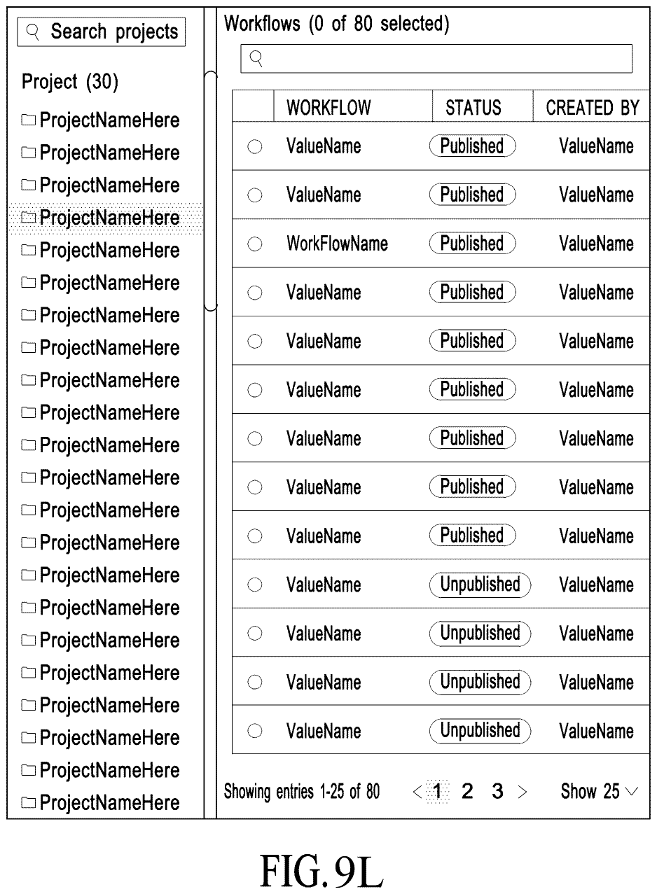

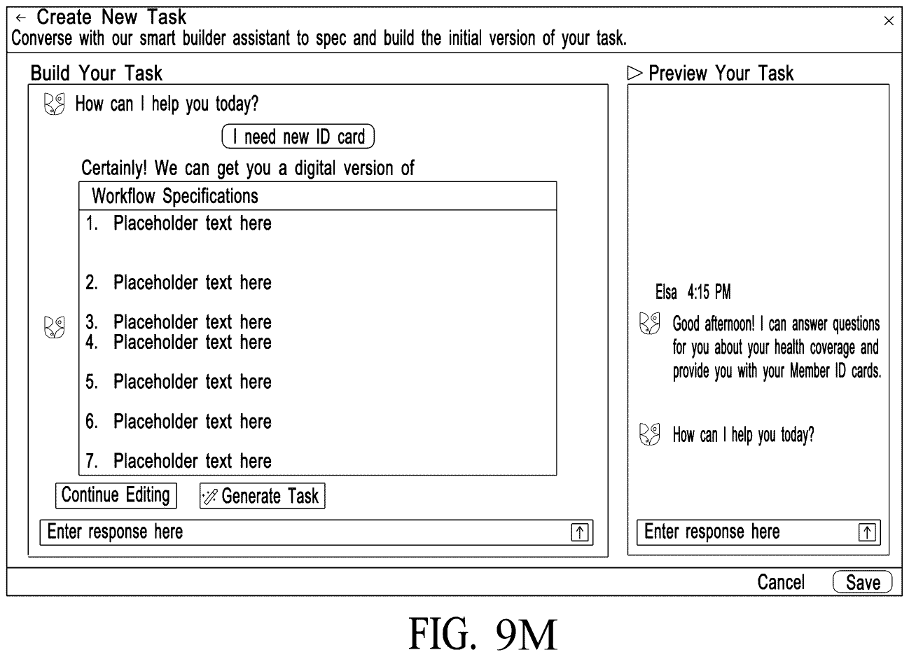

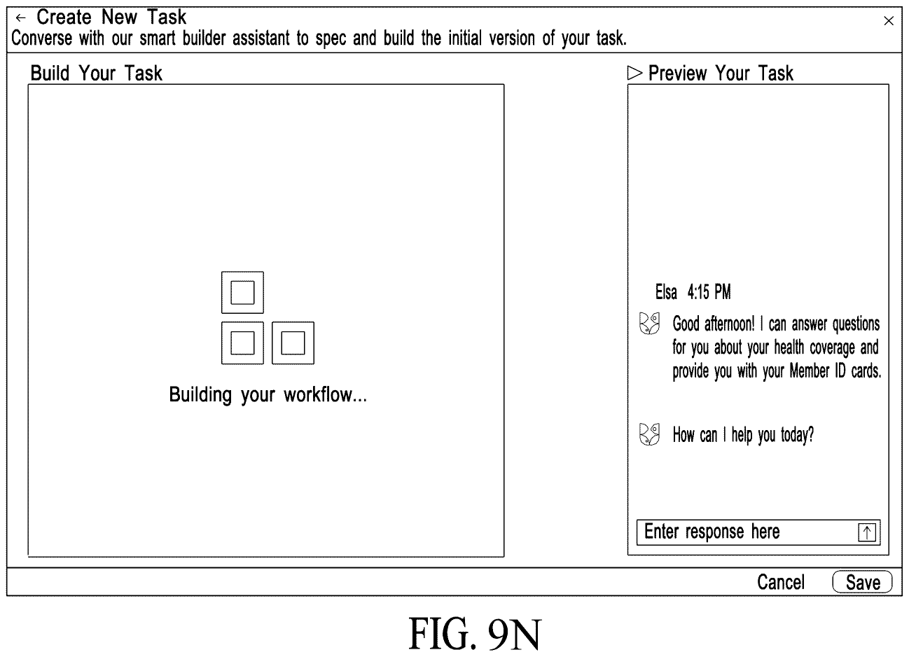

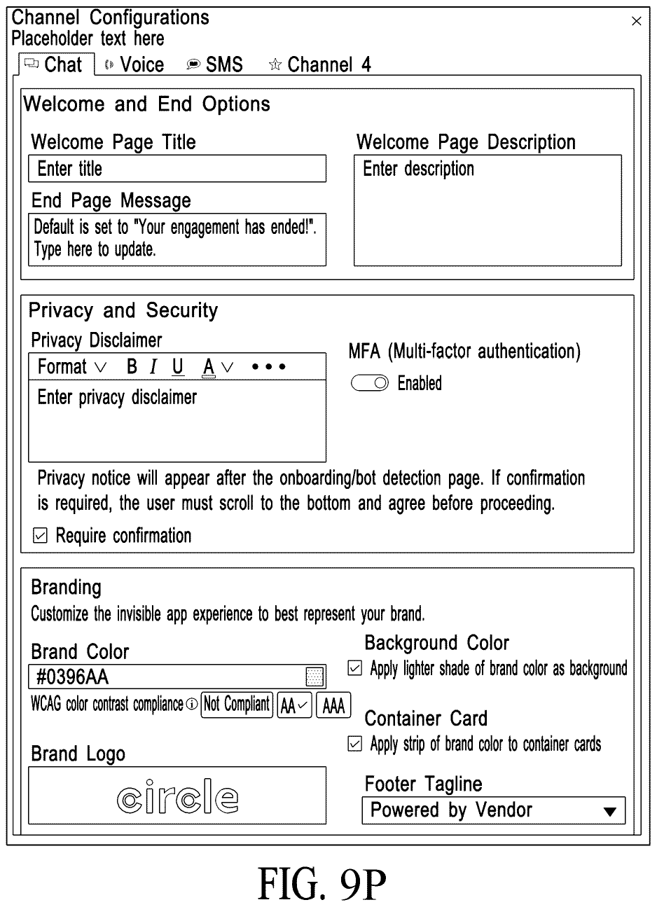

FIGS. 9A to 9P illustrate AI Agent creation capabilities in accordance with this disclosure.

The AI Agent Creation Board within the AXA platform allows users to quickly design and deploy AI Agents that are compliant, secure, and tailored to specific industry needs. This streamlined process ensures that agents are configured to perform specialized roles while adhering to enterprise security and regulatory standards.

FIG. 9A illustrates features of the AI Agent creation interface, according to some embodiments. In some embodiments, the AI Agent creation interface can include an agent name and agent description. An agent name refers to a unique internal name assigned to an agent (e.g., by a user) for identification and management purposes within the AI Agent Studio. An agent description refers to a description (e.g., an outline) of the agent's purpose, functional scope, and intended tasks within the automation ecosystem.

In some embodiments, the AI Agent creation interface can include starting templates for rapid configuration, or predefined templates to simplify the setup process (e.g., by assigning specialized roles to the agent based on common industry use cases). For example, a starting template can include a Health Plan Member Engagement designed for engaging healthcare members, handling tasks such as eligibility checks, ID card downloads, provider searches, and address updates. Another example includes an RFP Quote Intake tailored for processing Request for Proposal (RFP) submissions, automating data extraction, document classification, and workflow routing for faster response times. An additional example includes an Email Triage focused on classifying, prioritizing, and routing incoming emails for customer support, automating repetitive tasks like ticket assignment or response drafting.

In some embodiments, the AI Agent creation interface can integrate security and compliance standards. For example, during agent creation, security protocols and compliance standards (e.g., HIPAA for healthcare agents, GDPR for data privacy) are embedded to ensure agents operate within regulatory guidelines from deployment, in some embodiments.

The AI Agent Creation Board demonstrates the platform's ability to rapidly configure specialized, compliant agents for various industries, which is critical in showcasing the agentic flexibility of AXA. By incorporating industry-specific templates and automated compliance protocols, AXA differentiates itself from standard automation tools that require more manual setup and lack dynamic, context-aware agents.

FIG. 9B shows how as part of the AI Agent creation process, a persona can be selected and customized. Selecting the right persona is critical to defining how the agent will interact with users. The persona shapes the tone, communication style, and overall user experience, ensuring the agent aligns with the brand voice and customer expectations in different industries.

In some embodiments, persona selection can include predefined persona options, or a range of pre-configured personas tailored to different use cases, allowing enterprises to customize the tone and approach of the AI Agent. An example of a predefined persona can include a Friendly Health Advisor that provides empathetic, supportive guidance in a warm, approachable tone, ideal for healthcare engagements. An additional example of a predefined persona can include a Factual Information Provider that offers concise, accurate, and objective information without embellishment, suitable for technical or compliance-driven environments. Another example of a predefined persona can include a Helpful Insurance Guide that balances professionalism with a helpful, customer-first approach, guiding users through complex insurance processes with clarity and support.

In some embodiments, persona selection can include assigning a customer-facing agent name in addition to the internal agent name to personalize interactions with users. The customer-facing agent name ensures the agent presents a consistent and relatable identity to end-users. For example, an agent can have the internal name “HealthPlan_AI_001” and the customer-facing name “Your Health Assistant, Ava.”

Detailed persona selection and customizable agent identities emphasizes how AXA's agentic execution is not only intelligent but also user-centric. The ability to define personalized interaction styles ensures that AI Agents can deliver experiences that feel authentic and human-like, a key differentiator in experience automation.

FIG. 9C illustrates AI Agent's capability assignment and configuration. In the AI Agent Creation process, assigning capabilities is a crucial step that defines what the agent can do within the AXA platform. The system allows capabilities to be discovered and assigned in a conversational, intuitive manner, making it easy for users to equip agents with the right functionalities.

In some embodiments, the capability assignment process can include a conversational discovery of capabilities. For example, capabilities can be searched and assigned using a natural language interface. Users can describe the functionality they need in simple terms, and the system will suggest the appropriate capabilities, in some embodiments. For example, upon receiving the user input “I want this agent to help members find their ID cards,” the system can suggest to assign a capability to download ID cards to the agent.

Examples of capabilities that can be assigned include answering questions, updating addresses, downloading ID cards, scheduling appointments, and processing claims. Answering questions can refer to using Retrieval-Augmented Generation (RAG) to provide accurate, context-aware responses from connected knowledge bases, in some embodiments. In some embodiments, updating addresses refers to automating the process of collecting and updating customer address information in connected systems like CRM or EMR platforms. Downloading ID cards refers to when agents retrieve and send digital ID cards to users, typically used in healthcare and insurance workflows. Scheduling appointments refers to coordinating appointments based on user preferences and availability, integrating with calendar systems. Processing claims refers to automating the intake and preliminary evaluation of insurance claims using AI-driven document processing. In some embodiments, agents can be assigned custom capabilities. For example, users can define custom capabilities that align with unique business processes or industry-specific needs, which can be developed, configured, and assigned within the AI Agent Studio.

By highlighting the conversational capability assignment and the ability to dynamically configure agent functions, we are showcasing the user-friendly, flexible nature of the AXA platform. This approach distinguishes AXA from rigid, pre-configured automation systems by allowing real-time customization and adaptive task assignment to AI Agents.

FIG. 9D shows assigning knowledge bases to AI Agents.

A critical part of the AI Agent Creation process within the AXA platform is the assignment of a knowledge base. This equips the agent with the necessary domain-specific information to perform tasks such as answering questions, providing guidance, and executing context-aware workflows. The knowledge base can be created by uploading documents like PDFs or Excel files, which the agent accesses using Retrieval-Augmented Generation (RAG) techniques.

Users can upload various document types to serve as the agent's knowledge base, for example: PDFs for comprehensive documents like policy manuals, user guides, or training materials, Excel Files (XLS/XLSX): For structured data like contact lists, product catalogs, or pricing tables.

Once uploaded, the documents are indexed and made accessible to the agent using RAG techniques. In the “retrieval” part, the agent can search the knowledge base to find the most relevant content in response to user queries. For the “Augmentation” part, the retrieved content is then combined with the agent's LLM capabilities to generate accurate, contextually relevant responses.

This approach ensures the agent is both informed by enterprise-specific knowledge and capable of delivering precise, real-time answers.

Agents can be assigned multiple knowledge sources, allowing them to cross-reference information from different documents or datasets for more comprehensive responses.

For instance, an agent handling health plan member inquiries might have access to: Member Benefits PDF, Provider Directory Excel Sheet, Claims Processing Guidelines Document etc.

The knowledge base can be updated dynamically with new uploads, and the agent will automatically integrate this information into future interactions. Version control ensures that agents always refer to the most current and accurate data.

This RAG-powered knowledge base assignment process adds to the agentic capabilities of AXA. By enabling agents to access enterprise-specific knowledge dynamically and augment responses with LLM-driven reasoning, the system delivers adaptive, intelligent experiences that go beyond static automation. This dynamic integration of uploaded documents into real-time agent behavior is a novel approach in experience automation.

Once the template, agent persona, knowledge base, and capabilities have been assigned, the AI Agent is ready for deployment within the AXA platform. However, for enterprises seeking to tailor their agents even further, the system offers optional advanced configurations to fine-tune the agent's behavior and performance.

FIG. 9E illustrates finalization and advanced configuration as the fifth step of creating the AI agent in the given interface

There is a Standard Configuration that is ready-to-deploy. In some embodiments, the agent is fully functional and can be deployed immediately with components including a starting template, an agent persona, a knowledge base, and capabilities. A starting template can include predefined workflows aligned with specific use cases (e.g., Health Plan Member Engagement, RFP Quote Intake), in some embodiments. An agent persona can refer to a defined tone, communication style, and interaction preferences (e.g., Friendly Health Advisor, Factual Information Provider) for the agent. In some embodiments, knowledge base refers to uploaded PDFs or Excel files accessible via RAG for dynamic, informed responses. Capabilities can refer to assigned functionalities such as answering questions, updating addresses, or downloading ID cards.

Enterprises can choose to further customize agents to align with specific business goals, user preferences, or regulatory requirements with optional Advanced Configuration. In some embodiments, Advanced Configuration Options can include persona fine-tuning, custom task workflows, channel configuration, integration settings, and security and compliance settings. Persona fine-tuning refers to adjusting agent tone, formality, empathy, proactivity, or humor to reflect brand-specific communication guidelines. Custom task workflows refer to creating and/or modifying workflows to handle complex, multi-step processes unique to the organization. Channel configuration refers to defining specific communication channels (e.g., email, chat, SMS) the agent will use to engage with users. Integration settings refer to customizing API integrations with external platforms like Salesforce, EMRs, or contact center software. Security and compliance settings refer to configuring data handling and privacy settings to comply with HIPAA, GDPR, or other industry-specific regulations.

Before deployment, the system can provide a preview environment where users can simulate interactions with the agent to ensure it behaves as intended. Testing scenarios help verify that workflows execute correctly, knowledge retrieval is accurate, and the agent persona aligns with expectations.

By allowing enterprises to deploy ready-to-use agents quickly while offering deep customization options, AXA demonstrates a level of flexibility and adaptability that distinguishes it from traditional automation platforms. The ability to fine-tune agent personas, configure complex integrations, and adjust communication channels showcases AXA's agentic versatility, reinforcing its position as a novel experience automation system.

FIG. 9F shows the persona customization interface. The Persona Customization feature within the AI Agent Creation process allows enterprises to finely tune the personality and communication style of their AI Agents. This ensures that interactions are aligned with brand identity, user expectations, and industry-specific requirements. The customization process provides granular control over the agent's tone, behavior, and engagement approach.

In some embodiments, Persona Customization Interface provides core persona details including a primary name, agent role, description, and timestamps. A primary name refers to the agent's user-facing identity, which can differ from the internal name for branding purposes. An agent role refers to the specific function the agent is designed to perform (e.g., Health Advisor, Insurance Guide, Customer Support Specialist). A description refers to a concise summary of the agent's purpose, detailing how it is expected to interact with users. Timestamps refer to metadata indicating the creation date, last modified date, and deployment status of the persona configuration.

In some embodiments, Persona profile can have customizable attributes (communication style and behavioral characteristics), such as tone, formality, empathy, humor, politeness, and proactivity. Tone refers to an agent's overall voice, such as friendly, professional, casual, or formal. Formality refers to the level of professional language used in interactions, suitable for different audiences (e.g., formal for legal services, casual for retail). Empathy refers to the degree to which the agent displays understanding and compassion in sensitive situations, such as healthcare or customer complaints. Humor refers to the capability of the agent to include light, appropriate humor when engaging with users, useful in consumer-facing roles. Politeness refers to how courteous and respectful the agent is in its responses, which can vary by cultural or organizational norms. Proactivity refers to how actively the agent offers suggestions, reminders, or follow-up actions without being explicitly prompted by the user.

Agents can be configured with multiple persona profiles to handle different interaction scenarios or user segments. For example, the same agent might adopt a formal, factual tone when dealing with corporate clients but switch to a friendly, empathetic approach when engaging with individual consumers.

FIG. 9G shows an AI Agent Dashboard that serves as the central hub for managing and monitoring each AI Agent within the AXA platform. It provides a holistic view of the agent's configuration, properties, and real-time activities, enabling users to oversee both the operational performance and behavioral attributes of their agents. The dashboard also offers analytics, status updates, and visual insights to ensure agents are performing optimally in delivering autonomous, agentic experiences.

In some embodiments, the AI Agent Dashboard can include an Agent Configuration Overview, Real-Time Activity Monitoring, Analytics and Performance Metrics, Status and Health Monitoring, and Interactive Controls and Adjustments. The Agent Configuration Overview displays all core configuration settings for the agent, including an agent name and role, persona attributes, capabilities, knowledge base links, and integrations. The agent name and role includes identifying information and the assigned functional role (e.g., Health Plan Advisor, Claims Processor), in some embodiments. Persona attributes include the agent's tone, empathy, formality, and other personality traits defined during creation. Capabilities include a list of tasks and functions the agent can perform (e.g., answering questions, processing claims, updating records). Knowledge base links include documents and data sources (PDFs, Excel files) assigned to the agent, accessible via RAG for informed responses. Integrations include connected platforms and APIs (e.g., Salesforce, EMR systems, contact center software).

In some embodiments, Real-Time Activity Monitoring can include providing live updates on the agent's current tasks, workflows in progress, and interactions with users and tracking agent status in real time. Tracking agent status can include tracking active sessions (e.g., ongoing user interactions or workflows the agent is managing), pending tasks (e.g., queued actions awaiting execution), and/or error handling (e.g., notifications for execution failures, API errors, or issues requiring intervention), in some embodiments.

In some embodiments, analytics and performance metrics include interaction metrics, workflow success rate, user satisfaction scores, decision accuracy, and/or engagement trends. Interaction metrics can include the number of user interactions handled, average response times, and resolution rates. Workflow success rates refer to the percentage of workflows successfully completed without manual intervention. User satisfaction scores include feedback from end-users on the agent's performance, tone, and helpfulness. Decision accuracy refers to accuracy rates for agents handling complex tasks, such as classification or extraction. Engagement trends refer to charts showing peak interaction times, common user queries, and areas where the agent is most utilized.

In some embodiments, status and health monitoring can include Uptime/Downtime Reports, System Resource Usage, and/or Version Control and Updates. Uptime/Downtime Reports refer to ensuring the agent is always available for mission-critical tasks. System Resource System Resource Usage refers to monitoring the computational resources used by the agent for performance optimization. Version Control and Updates refers to tracking the current version of the agent, along with a history of configuration changes and updates.

In some embodiments, interactive controls and adjustments refer to components that allow users to make real-time adjustments to the agent's behavior directly from the dashboard. Examples of adjustments include updating persona traits (e.g., adjusting tone, empathy, or proactivity based on current performance data), modifying workflows (e.g., adding or removing tasks from the agent's capabilities on the fly), and knowledge base updates (e.g., uploading new documents or data sources without redeploying the agent), in some embodiments.

The AI Agent Dashboard represents a key differentiator in the AXA platform by offering a comprehensive, real-time management interface that not only tracks performance but also allows for dynamic adjustments to agent behavior. The ability to monitor, analyze, and adapt AI Agents on-the-fly ensures that automation is not only autonomous but also responsive to enterprise needs in real time. This level of visibility and control over agentic execution adds depth to the invention and showcases the unique adaptability of the AXA system.

FIG. 9H shows AI Agent training including knowledge skill development and Retrieval-Augmented Generation (RAG) integration. The AI Agent Training module within the AXA platform enables agents to be equipped with specialized knowledge skills by ingesting and learning from multiple data sources. This training process is powered by Retrieval-Augmented Generation (RAG), which grounds the underlying LLM with the uploaded data, ensuring the agent delivers accurate, contextually relevant responses during interactions.

In some embodiments, key features of AI Agent training with knowledge skills include, but are not limited to multi-source data upload for training, RAG-powered knowledge integration, knowledge prioritization and query handling, interactive Q&A testing environment, and/or continuous knowledge updates and retraining. Multi-source data upload for training refers to uploading multiple datasets to train the AI Agent, such as PDFs for comprehensive documents (e.g., manuals, policy guidelines, and user instructions), Excel Files (XLS/XLSX) for structured data (e.g., as product catalogs, price lists, or contact databases), and/or CSV and JSON Files for more technical datasets (e.g., logs, reports, or API outputs). The system supports bulk uploads and version control, ensuring agents are always trained on the most current data, in some embodiments.

In some embodiments, the training process leverages Retrieval-Augmented Generation (RAG) to ground the agent's responses in the uploaded datasets. Retrieval refers to when the AI Agent first queries the uploaded knowledge base to retrieve the most relevant information in response to a user question. Augmentation refers to when retrieved content is then combined with the agent's LLM capabilities to generate an informed, coherent response. This ensures that the agent prioritizes enterprise-specific knowledge before defaulting to general data from the broader model.

In some embodiments, the system is designed to prioritize the knowledge base assigned during training. For example, when handling queries, the agent will first search the uploaded datasets via RAG. If the required information is not found in the knowledge base, the agent will then query external or broader datasets as a fallback. This ensures that the agent remains aligned with enterprise-specific information and policies while maintaining the flexibility to handle broader queries when needed.

In some embodiments, after training, users can engage in a Q&A session with the AI Agent to test its knowledge retrieval and response accuracy. This interactive testing environment allows users to validate that the agent correctly retrieves and interprets information from the uploaded datasets, fine-tune knowledge prioritization to ensure the agent references the correct sources in multi-layered datasets, and identify any gaps or inconsistencies in the knowledge base for further refinement.

In some embodiments, the AI Agent's knowledge can be continuously updated with new data uploads. The system allows for incremental retraining, ensuring that updates do not require full model retraining but instead build on existing knowledge. Agents can be scheduled for periodic retraining to keep their knowledge base current without manual intervention.

The AI Agent Training process, powered by RAG, introduces a dynamic knowledge integration framework that allows agents to prioritize enterprise-specific data while maintaining the flexibility to handle broader queries. The ability to upload multiple datasets, train agents in real time, and validate their knowledge retrieval capabilities positions AXA as a highly adaptable, enterprise-focused automation platform. This process of grounding LLMs with domain-specific knowledge for agentic execution adds a strong technical layer to the proposed system, highlighting both the novelty and practical application of the system.

FIG. 9I shows an AI Agent Capabilities Dashboard providing a comprehensive overview of skills, integrations, and tasks. The AI Agent Capabilities Dashboard within the AXA platform provides a centralized view of all the functionalities and features assigned to each AI Agent. This dashboard offers a detailed breakdown of the agent's AI skills, integrations, and task assignments, allowing enterprises to monitor and manage the agent's capabilities in a structured and intuitive manner.

Key features of the AI Agent Capabilities Dashboard includes. AI Skills and Features Overview. The Overview displays the full range of AI-driven functionalities the agent possesses, including, but not limited to: Question Answering (Using Retrieval-Augmented Generation (RAG) for context-aware responses); Information Extraction (Pulling key data points from structured and unstructured documents); Text Classification (Categorizing incoming data, such as email triage or document tagging); Sentiment Analysis (Evaluating user emotions and adjusting responses accordingly), and Personalization Features (Tailoring interactions based on user preferences and historical data).

The key features also include Integrations Management, including showing all third-party platforms and enterprise systems connected to the AI Agent, enabling seamless data flow and process automation. Common examples of Integrations Include: Salesforce for customer data management and workflow triggers, Five9 for contact center interactions and call routing; EMR Systems for accessing and updating electronic medical records in healthcare workflows, and Custom APIs for integrating with proprietary systems or tools specific to the enterprise.

The key features also include Task and Workflow Assignment including listing all tasks and workflows assigned to the AI Agent, along with their current status and priority levels. Tasks can be categorized by type, such as: Operational Tasks (e.g., updating user information, processing claims); Communication Tasks (e.g., sending notifications, managing multi-channel dialogues); Decision-Making Tasks (e.g., approving requests based on predefined criteria or real-time analysis).

Another feature is Dynamic Task Assignment, i.e. new tasks can be added, and existing ones can be modified directly from the dashboard, allowing the agent's role to evolve with business needs.

The key features also include Performance Insights and Usage Metrics. This feature provides real-time analytics on the agent's capabilities usage, including but not limited to: Most Frequently Used Skills (Identifying which features are leveraged most often); Integration Health (Monitoring the status and reliability of connected systems); Task Completion Rates (Tracking how effectively the agent completes assigned workflows) etc.

Yet another key feature is custom capability development and deployment. Enterprises can develop custom AI skills or integrations and deploy them directly to the agent via the dashboard. This feature allows for rapid scaling and the introduction of new functionalities without disrupting existing workflows.

The AI Agent Capabilities Dashboard exemplifies the modularity and flexibility of the AXA platform, allowing for the dynamic management of an agent's skills, tasks, and integrations. The ability to monitor, adjust, and expand an agent's capabilities in real-time contributes to the platform's agentic nature, emphasizing autonomous adaptability. This centralized capability management system enhances the novelty of AXA's design, further solidifying its place as a unique, intelligent experience automation solution in the proposed environment.

FIG. 9J illustrates AI Agent Extraction Skill Configuration and Training view. The AI Agent Extraction Skill view within the AXA platform offers a focused interface where agents can be trained and configured to extract specific information from a wide range of documents. This skill allows agents to handle complex data extraction tasks with high accuracy, leveraging prompt-based training to refine their understanding of document structures and data patterns.

The document repository for extraction displays all the uploaded documents that the agent can process for extraction tasks. The system supports varied document types, including, but not limited to: bank statements (extracting transaction details, balances, account numbers), driver licenses (retrieving personal identifiers like name, date of birth, and license numbers), identity documents (Extracting government-issued IDs, passport details, or social security numbers), ACORD forms (Pulling standardized insurance form data, such as policy numbers and coverage details). pay slips (extracting salary information, tax deductions, and employment details), tax documents (identifying key financial data, deductions, and tax filing statuses) etc.

The system allows for prompt-driven training where users can guide the AI Agent on how to extract specific fields from the provided documents. Some example prompts can include: “Extract the total account balance from the bank statement,” “Identify the policyholder's name and coverage period from the ACORD form,” “Retrieve the gross income and tax deductions from the pay slip,” etc. This iterative prompt training refines the agent's ability to recognize document layouts, variable formats, and contextual data across different document types.

The AI Agent is trained to adapt to various formats of the same document type, ensuring consistent performance even when document structures vary (e.g., different bank templates or identity documents from multiple regions). The agent can identify patterns and adjust extraction logic dynamically, improving accuracy over time.

After training, users can validate extraction accuracy by testing the agent on sample documents. The system highlights extracted data fields for user review and feedback, allowing for further fine-tuning if needed. Error handling mechanisms flag any inconsistencies or extraction failures for corrective action.

Once trained, the extraction skill can be integrated into larger workflows, automating tasks such as: populating CRM systems with extracted customer data, automating claims processing using data from ACORD forms, verifying identity information in KYC (Know Your Customer) processes, generating reports based on extracted financial or tax data etc.

The Extraction Skill view showcases AXA's ability to train AI Agents dynamically for complex document processing tasks using prompt-based learning. By supporting a wide range of document types and allowing agents to adapt to varied formats, this feature highlights the agentic adaptability and context-aware intelligence at the heart of AXA. The ability to integrate these extraction skills into broader automated workflows further strengthens the platform's unique positioning in the experience automation space, enhancing the overall novelty and scope of the solution.

FIG. 9K illustrates classification skill configuration and training for email triaging of an AI agent, in accordance with some embodiments of the present disclosure.

The Classification Skill view within the AXA platform is designed to train AI Agents to analyze and categorize incoming emails based on their content. This skill enables agents to perform email triaging by identifying the intent and topic of each message, ensuring that emails are routed to the correct departments or workflows for efficient handling.

In some embodiments, the Classification view can have the feature of email data ingestion and analysis. The system imports incoming emails for classification, focusing on the subject line (for quick identification of high level topics), body of the email (for deeper content analysis and intent recognition), and attachments (to provide context or additional data for classification), in some embodiments. The agent processes these components to determine the relevant topic and urgency of the email.

Users can train the AI Agent using prompts that define how to recognize and classify specific email types. Some example prompts are: “Classify emails requesting a quote as ‘Sales Inquiry,’” “Identify emails reporting service outages as ‘Technical Support,’” “Flag emails containing billing issues as ‘Payment Dispute,’” “Route emails with feedback or suggestions to ‘Customer Experience,’” etc. The system refines its classification model based on these prompts, learning to detect keywords, phrases, and contextual cues.

The AI Agent can handle emails containing multiple intents or overlapping topics. For example, an email that includes both a billing question and a technical issue will be flagged for multi-department routing or prioritized based on urgency.

Users can define custom classification categories tailored to their business needs, ensuring the system aligns with organizational workflows. Non-limiting examples of custom categories include insurance (e.g., Claims Inquiry, Policy Renewal, Coverage Verification), healthcare (e.g., Appointment Scheduling, Prescription Refill, Medical Records Request), and finance (e.g., Loan Application, Fraud Alert, Account Closure Request).

After training, users can test the classification accuracy using sample emails. The system provides a confidence score for each classification, allowing users to review and refine the agent's decision-making process. Misclassifications can be flagged for correction, and the agent will adjust its model based on feedback.

Once classified, emails can be automatically routed to the appropriate team or trigger specific workflows within the enterprise. For example, sales inquiries can trigger a lead generation workflow in CRM systems (e.g., Salesforce). In another example, Technical Support Requests are sent to the IT helpdesk system. An additional example can include routing Billing Disputes to the accounts receivable department for immediate attention.

The Classification Skill view showcases the AXA platform's ability to train AI Agents for intelligent email triaging, transforming a traditionally manual process into an autonomous, context-aware system. By using prompt-based learning to classify emails and integrating the results into automated workflows, AXA provides a dynamic, adaptable solution for managing high volumes of customer communications. This approach to email classification and routing, combined with the agentic framework, adds significant depth to the solution, highlighting both novelty and practical enterprise application.

FIG. 9L illustrates AI Agent workflow assignment dashboard for managing and monitoring workflow integration, in accordance with some embodiments of the present disclosure.

The Workflow Assignment Dashboard within the AXA platform provides a centralized interface for managing all existing workflows that can be assigned to AI Agents. This dashboard offers a detailed overview of the status, properties, and execution parameters of each workflow, enabling enterprises to effectively coordinate how agents engage with various tasks and processes.

On the Workflow Assignment Dashboard, there can be a comprehensive workflow listing that displays all available workflows within the AXA platform that can be assigned to AI Agents. In some embodiments, each workflow entry can include a workflow name and description (e.g., identifying the task or process, such as Claims Processing, Customer Onboarding, or Member Eligibility Verification), type of workflow (e.g., whether it is rule-based, agentic, or a hybrid workflow combining both), and associated AI Agents (e.g., indications of which agents are currently assigned to the workflow).

The Workflow Assignment Dashboard can also provide status monitoring and execution tracking, in some embodiments. Real-time status indicators show the current state of each workflow, such as active (e.g., workflow is currently being executed by the agent), pending (e.g., workflow is queued for execution), completed (e.g., workflow has been successfully executed), and/or failed/error (e.g., workflow encountered issues during execution, with error logs for troubleshooting). In some embodiments, the Workflow Assignment Dashboard can include an execution history that provides a log of past executions, including timestamps, outcomes, and agent performance metrics.

On the dashboard, Workflow Properties and Assignment Details displays the properties of each workflow, in some embodiments. Properties can include complexity level (e.g., simple task, multi-step process, or dynamic, agentic workflow), dependencies (e.g., lists of any prerequisites, triggers, or external integrations required for the workflow), and/or execution rules (e.g., rules that define whether the agent has autonomous control over workflow execution or if human-in-the-loop approval is required).

On the dashboard, Dynamic Workflow Assignment and Reassignment allows users to assign or reassign workflows to different AI Agents based on performance or task requirements. Bulk assignment is possible, i.e., multiple workflows can be assigned to a single agent or distributed across several agents for load balancing.

The dashboard includes options to create new workflows or modify existing ones, ensuring agents can be adapted to evolving business needs.

Workflows can be connected to third-party platforms (e.g., Salesforce, Five9, EMR systems) directly from the dashboard.

The dashboard has an option to provides analytics and visualizations on workflow performance, including success rates (e.g., percentage of workflows completed without errors), execution time (e.g., average time taken for each workflow), and/or agent efficiency (e.g., insights into how well agents handle assigned workflows, including bottlenecks and optimization opportunities).

The Workflow Assignment Dashboard highlights the modular and flexible nature of the AXA platform, allowing AI Agents to be dynamically assigned and reassigned workflows based on real-time data and performance metrics. This capability ensures that workflows are not just statically executed but are integrated into a dynamic, agentic framework where agents can adapt and optimize task execution. The combination of real-time status tracking, automated workflow assignment, and performance analytics reinforces the novelty and practicality of AXA, strengthening its position in the experience automation space

FIG. 9M illustrates AI Agent smart builder for conversational task creation and agentic execution, in accordance with some embodiments of the present disclosure.

The Smart Builder within the AXA platform empowers users to create new tasks and workflows through a conversational interface. Leveraging the power of UshurLLM and the platform's agentic capabilities, users can describe their desired outcomes in natural language, and the system will automatically generate workflows that are executed autonomously by AI Agents. This feature simplifies the task creation process, making it accessible to non-technical users while maintaining the sophistication required for complex workflows.

Users can interact with the Smart Builder in a chat-based interface, describing the task they want the AI Agent to perform. In one example, the user inputs: “I need a new ID card.” The Smart Builder interprets this request and identifies the necessary steps to fulfill it. The first step can be to verify the user's identity through authentication. The second step can be to retrieve the user's ID card from the system. The third step is to deliver the digital ID card via the preferred communication channel (email, SMS, or app notification). The fourth step is to provide instructions for ordering a physical card if needed.

The system automatically generates this workflow and prepares it for agentic execution by the AI Agent. Once the task is described, the Smart Builder uses UshurLLM to: identify the required capabilities (e.g., identity verification, document retrieval, multi-channel communication)., generate the workflow logic, ensuring it aligns with enterprise policies and user-specific data, and format the workflow into AXA Declarations for seamless integration with the Multi-Agent System (MAS).

The AI Agent then executes the workflow in an agentic manner, meaning it can: adapt dynamically based on the authentication results or system responses, adjust delivery methods if, for example, the email fails or the user requests an alternative channel, and collaborate with other agents if additional verification or processing is needed.

After the workflow is generated, users can preview the task to review the process flow and ensure it matches their intent. In the testing environment, the system simulates the ID card retrieval and delivery process, allowing users to verify the authentication flow, confirm the correct ID card is retrieved, test the delivery channels (email, SMS, app notifications etc.). Any discrepancies can be flagged and corrected before final deployment.

Users can make real-time adjustments to the workflow, such as: adding a security step for multi-factor authentication, including notifications for support teams if the process fails, adjusting the communication tone based on the user's profile etc.

Once finalized, the workflow is deployed, and the AI Agent begins autonomous execution, managing future ID card requests seamlessly.

The Smart Builder's conversational task creation and its ability to translate simple requests like “I need a new ID card” into agentically executed workflows highlight AXA's innovative approach to experience automation. This functionality bridges the gap between natural language input and complex automation execution, allowing for real-time task creation that is dynamic, adaptive, and autonomous. By integrating UshurLLM with the Multi-Agent System (MAS) for both workflow generation and execution, AXA introduces a unique, user-centric automation framework that strengthens the solution's novelty and scope.

FIG. 9N illustrates AI Agent task execution dashboard for building, simulating and agentic execution of tasks, in accordance with some embodiments of the present disclosure.

The Task Execution Dashboard within the AXA platform is where AI Agents build, execute, and simulate tasks in a controlled environment. This dashboard offers users a space to create tasks, test their behavior in a simulated runtime, and observe how they are executed in an agentic manner. The system ensures that tasks are not only configured correctly but are also capable of adapting dynamically to real-world conditions before full deployment.

Users can build and configure new tasks by defining the desired outcomes and assigning the necessary capabilities to the AI Agent. Tasks can include: simple actions (e.g., sending a notification, retrieving a document), complex workflows (e.g., multi-step processes involving authentication, data extraction, and multi-channel communication), and dynamic processes, i.e. tasks that involve conditional logic or real-time decision-making based on user input or system responses.

The dashboard includes a simulated testing environment area where users can test tasks before deploying them into the live environment. Users can interact with the AI Agent as if they were an end-user, providing inputs and observing responses.

The agent's decision-making process and workflow execution are displayed in real time, allowing users to see how tasks are handled under various conditions. An example simulation is shown here.

For a task like “I need a new ID card,” the simulation would show the AI Agent's authentication steps, the retrieval of the correct ID card, the dynamic choice of delivery method based on user preferences, and the agent's response to potential errors, such as failed authentication or missing data.

During simulation, the system highlights how the AI Agent executes tasks agentically, meaning it adapts workflows in real-time based on incoming data or unexpected conditions, collaborates with other agents if the task requires multi-agent coordination, makes autonomous decisions without human intervention, adjusting its behavior to optimize outcomes.

If errors or other issues arise during simulation, the dashboard provides detailed error logs and troubleshooting suggestions. Users can modify the task configuration directly from the dashboard to address errors and re-run the simulation to verify fixes.

In some embodiments, after successful simulation, the dashboard provides performance metrics to help optimize the task before deployment, including execution time (e.g., how long it takes the agent to complete the task), decision accuracy (e.g., the agent's success rate in making correct decisions during task execution), and resource utilization (e.g., the computational resources required to execute the task).

Once tested, tasks can be deployed directly from the dashboard, and the AI Agent will begin live execution in the production environment. The dashboard continues to monitor live task performance, providing real-time insights and allowing for ongoing adjustments if needed.

The Task Execution Dashboard showcases the AXA platform's ability to build, simulate, and execute tasks in an agentic manner. By providing a simulated environment where users can interact with AI Agents and observe real-time decision-making, AXA ensures that tasks are not only functional but also capable of autonomous adaptation. The integration of dynamic simulation with agentic execution monitoring represents a novel approach to experience automation, highlighting both the technical sophistication and user-centric design of the platform. This feature significantly strengthens the proposal by demonstrating AXA's unique ability to bridge task creation, testing, and autonomous execution in a seamless, adaptable framework.

FIG. 9P illustrates AI Agent channel configuration dashboard for multi-channel engagement setup and customization, in accordance with some embodiments of the present disclosure.

The Channel Configuration Dashboard within the AXA platform provides a centralized interface for setting up and managing the communication channels through which AI Agents engage with users. This dashboard allows for the seamless integration of chat, voice, SMS, and other channels, ensuring that agents deliver consistent, branded, and secure experiences across all touchpoints.

The dashboard supports configuring multiple communication channels for AI Agents, including Chat Platforms (e.g., web chat, in-app messaging, Microsoft Teams, Slack), Voice Channels (e.g., VoIP systems, contact center integrations like Five9, or virtual assistants like Alexa), SMS Messaging (for quick, text-based interactions, including notifications and two-way conversations), Email (for formal, asynchronous communication workflows), and/or Other Channels (e.g., integration with social media platforms, customer portals, and enterprise-specific tools).

The dashboard allows configure customized introduction messages tailored to each channel, ensuring the AI Agent establishes an appropriate tone and context at the start of every interaction. For example, a configuration can include a chat (e.g., “Hi! I'm Ava, your virtual health assistant. How can I assist you today?”), voice (e.g., “Welcome to [Company Name]. I'm your automated assistant. Please tell me how I can help you”), and/or SMS (e.g., “Hello! This is [Agent Name] from [Company]. Reply to this message if you need assistance with your account”).

The dashboard includes options to ensure secure and privacy-compliant communication across all channels. Data encryption is available for secure data transmission for sensitive information, especially on voice and SMS channels. User authentication features, such as Multi-factor authentication (MFA) options for verifying users before sharing personal or confidential data are available. The compliance configurations ensure adherence to industry regulations like HIPAA for healthcare, GDPR for data privacy, and PCI DSS for financial transactions.

Branding and Customization is also supported. User can configure channel-specific branding elements to ensure a consistent enterprise identity across all user interactions. Voice channel branding can use branded greetings, hold music, and voice tone customization. Chat and SMS branding can incorporate logos, color schemes, and message templates aligned with the company's visual identity. Email branding can include customizable email signatures, headers, and templates to ensure brand consistency in automated communications.

This dashboard also allows tailoring the AI Agent's persona attributes to suit the communication style of each channel. Example Adjustments: using a more formal tone in emails, while maintaining a friendly, conversational tone in chat and SMS; using higher proactivity settings in chat (suggesting next steps) but more reserved in voice interactions.

This ensures that the agent's interactions are contextually appropriate for each communication medium.

The dashboard provides real-time analytics on agent performance across channels, including engagement metrics (e.g., number of interactions per channel, response times, and user satisfaction scores), channel efficiency (e.g., success rates of workflows initiated through different channels), and/or user preferences (e.g., insights into which channels are most preferred by users for different types of interactions).

The Channel Configuration Dashboard highlights AXA's ability to unify multi-channel communication within an agentic automation framework. By allowing AI Agents to engage seamlessly across chat, voice, SMS, and other platforms, while maintaining consistent branding, privacy, and security, AXA delivers a comprehensive and adaptable user experience. The ability to customize persona behavior, ensure regulatory compliance, and monitor channel-specific performance in real time showcases the technical sophistication and enterprise-readiness of the platform. This feature further strengthens the solution by demonstrating AXA's unique approach to dynamic, cross-channel experience automation.

As mentioned above, The AXA Declaration serves as the instructional language that guides AI Agents in executing tasks autonomously. This declarative framework outlines the intent, associated dependencies, and the logical flow required to complete a given task. The structure ensures that agents can interpret, plan, and execute workflows dynamically, adapting to real-time conditions and contextual requirements.

In some embodiments, the AXA Declaration includes an intent block and a dependencies block.

In some embodiments, the Intent block defines the primary goal or objective of the task the AI Agent needs to accomplish. For example, the agent intent can be to schedule an appointment with a physician.

In some embodiments, the Intent block also includes a description that provides a clear, human-readable explanation of what the intent entails. For example, a description can include “Book an appointment with an in-network physician for the member.” It specifies that the agent must ensure the physician is in-network, adhering to insurance requirements or organizational policies.

In some embodiments, the Intent block includes a dependencies section that outlines all the subtasks, rules, and conditions that must be fulfilled to complete the intent successfully. This ensures that the AI Agent follows a structured, logical path while retaining the flexibility to adapt dynamically.

In some embodiments, the Intent block includes nested intents that might be required to achieve the primary intent. In some embodiments, when no additional intents are necessary, the array is empty. For example, for a more complex task, such as “Complete Health Checkup Process,” nested intents could include “Schedule Lab Test” or “Request Medical Records.”

In some embodiments, the intent block also includes steps that refer to the sequential actions the AI Agent takes to fulfill the intent. Example steps can include “Authenticate Member,” “Search and Select Physician,” “Verify Physician Availability,” and “Confirm Appointment.” Authenticate Member verifies the member's identity using secure methods (e.g., multi-factor authentication). Search and Select Physician locates in-network physicians based on the member's preferences (location, specialty) and present options. Verify Physician Availability checks the physician's calendar for available appointment slots. Confirm Appointment finalizes the booking and send confirmation to the member via the preferred communication channel (email, SMS).

In some embodiments, the Intent block includes rules that specify any business rules or constraints for the AI Agent to follow during execution. For example, a rule can include “Disallow scheduling on government holidays.” In this example, the agent is programmed to prevent scheduling appointments on government holidays, ensuring compliance with provider availability policies.

In some embodiments, the Intent block includes one or more triggers that define the conditions that must be met before the workflow can begin. For example, a trigger can include authentication of a member, where the agent will proceed with scheduling the appointment after the member has been successfully authenticated. Additional triggers can include “Insurance Verified” or “Payment Processed” in more complex workflows, in some embodiments.

AXA Declarations enable agentic execution by a declarative approach, dynamic adaptation and context-aware execution.

Declarative approach refers to defining intents, dependencies, rules, and triggers. AXA Declarations allow AI Agents to interpret tasks autonomously without relying on rigid, pre-coded workflows, in some embodiments. Dynamic adaptation refers to when an AI Agent adapts the workflow dynamically, perhaps by suggesting an alternative provider or rescheduling when an unexpected event occurs (e.g., the physician is unavailable). Context-aware execution refers to rules and triggers that ensure that workflows are executed in a manner that aligns with business policies, regulatory requirements, and user expectations.

The AXA Declaration structure represents a proprietary framework for dynamic, agentic workflow execution. Unlike traditional process automation tools that rely on static, predefined scripts, this declarative language allows AI Agents to adapt, optimize, and autonomously execute complex workflows based on real-time data and contextual conditions. This flexibility and autonomy highlight the technical novelty of AXA.

The AXA Declarations framework defines how AI Agents within the AXA platform execute workflows autonomously by specifying intents, steps, rules, triggers, and contextual dependencies. This declarative structure enables the Multi-Agent System (MAS) to interpret tasks dynamically, adapt workflows in real time, and ensure that all processes align with business logic and compliance standards. Each component plays a crucial role in guiding the agent's actions while allowing flexibility to adjust to varying conditions during execution.

For example, in some embodiments, a conversation block can include a name that indicates that the agent is tasked with gathering the member's updated address. In some embodiments, the conversation block can include a type that indicates the step involves interacting with the user to collect input. In some embodiments, the conversation block specifies that data will be collected via a conversational interface (e.g., chat, SMS). The conversation block may also include dependencies that indicate when a step depends on prior criterion (e.g., member authentication to ensure secure data collection). In some embodiments, the conversation block includes a “context” section, that indicates for the agent to read member ID and authentication status, update the current address once collected, and log the completion status with a timestamp for audit and tracking.

In some embodiments, an example background (integration) block includes a name that indicates an instruction for the agent to search for in-network physicians based on user input. In some embodiments, the background block includes a “type” section that indicates the task involves an external API call to the CRM system to retrieve physician data. In some embodiments, the background block includes a “dependencies” section that indicates that the agent first authenticate the member before accessing physician data. The background block may also include a “customOverrides” section that allows the agent to override default configurations with specific API endpoints and HTTP methods, ensuring flexibility in integrating with different systems.

In some embodiments, a rules block (e.g., conditional logic) can include a “name” that defines a conditional rule to ensure the member is eligible before proceeding with the task. In some embodiments, the rules block includes a condition that indicates the agent will proceed if the member's eligibility status is active. In some embodiments, the rules block can include a fallback section that indicates that if the condition is not met, the agent will notify the member rather than proceed with the workflow. The rules block can also include a “dependencies” section that indicates the rule depends on the authentication status and the successful fetching of eligibility data. In some embodiments, the rule block includes the “context” section, where the rule logs its evaluation, providing a transparent audit trail.

For example, a trigger example block (e.g., event-based activation) can include a name section that refers to a trigger that initiates the workflow once a specific event (e.g., SMS delivery confirmation) is detected. In some embodiments, the trigger block includes a the “dependencies” section. For example, the dependencies section can indicate that the “Schedule Appointment” intent can only proceed if this event is successfully triggered. In a “context” section, the agent updates relevant data fields, like appointment status, and logs the event for tracking.

In the AXA Declaration framework, the context plays a pivotal role in ensuring that AI Agents have access to the necessary data, maintain state awareness, and generate audit-ready logs for every action they perform. This allows agents to execute tasks autonomously while remaining aligned with enterprise policies, compliance requirements, and workflow dependencies.

In some embodiments, the context can include a read Block that specifies the data fields that the AI Agent must access or retrieve to execute the current step or evaluate a rule. Fields can include a member identification that refers to the unique identifier for the member involved in the workflow. For example, in some embodiments, the member identification can be used to pull member-specific data from external systems (e.g., CRM, EMR). Other fields can include a current address, which refers to the address currently stored for the member. In an example, the current address can be used to compare against a newly provided address during an update process.

The context can also include an update Block that defines the data fields that the AI Agent will modify or update as a result of executing the current step or rule. For example, a validation status refers to the outcome of an address validation step, such as VALID, INVALID, PENDING_CORRECTION. In some embodiments, after validating the member's new address, the agent updates the validation status to reflect whether the address meets the required criteria.

The context may include a log Block that specifies how the AI Agent will log execution details for audit trails, performance monitoring, and compliance reporting. The log block can include lines that indicate that a specific rule or condition has been evaluated by the agent. The log may also log the result of the address validation. In some embodiments, the log may include a dynamic placeholder (e.g., {{ }}) that will be replaced with the actual validation result during execution. The log may also include timestamps that indicate the exact time when the rule was evaluated or the step was completed. This is critical for maintaining chronological records of agentic actions, which is essential for compliance and auditing.

Below it is described how context enables agentic execution. In some embodiments, the AI Agent can make context-aware decisions by defining what data to read and update (i.e., data driven decision making). For example, it will only proceed with updating an address if the validation status is VALID. The context ensures that agents maintain a clear understanding of the current state of the workflow, enabling them to adjust actions based on real-time conditions (i.e., state management). The logging mechanism provides a detailed audit trail of every decision the agent makes, ensuring transparency and compliance with enterprise policies and regulatory requirements (i.e., transparent and compliant logging).

The context management structure within AXA Declarations is a proprietary mechanism that empowers AI Agents to execute tasks with autonomous, context-aware intelligence. By defining explicit instructions on what data to access, update, and log, the framework ensures that workflows are not only dynamic but also transparent and compliant. This approach distinguishes AXA from traditional workflow systems by embedding real-time state management and auditable decision-making into every step of the execution process, enhancing the solution's technical novelty.

This AXA Declaration outlines the intent and the series of agentic steps required for an AI Agent to autonomously execute an address update workflow. By specifying the intent, steps, context, and action details, the AXA framework enables the AI Agent to manage the entire process, from authentication to data collection, validation, and system integration. Each step is designed to operate autonomously while being context-aware, ensuring seamless execution aligned with enterprise protocols.

In some embodiments, the AXA Declaration outlines the intent and the series of agentic steps required for an AI Agent to autonomously execute an address update workflow. By specifying the intent, steps, context, and action details, the AXA framework enables the AI Agent to manage the entire process, from authentication to data collection, validation, and system integration. Each step is designed to operate autonomously while being context-aware, ensuring seamless execution aligned with enterprise protocols.

In some embodiments, the intent Block can include the name section that defines the primary goal of the workflow: to update the member's address in the enterprise CRM system. The intent serves as the overarching directive that ties together the following series of steps.

In some embodiments, the steps block breaks down the individual tasks the AI Agent will autonomously execute to fulfill the intent. Each step is defined with its type, context, and specific action details, ensuring the agent can operate dynamically while adhering to the workflow structure.

In some embodiments, the AI Agent verifies the member's identity before proceeding with sensitive data updates. In some embodiments member verification is classified as a security-related task involving validation of user credentials. In some embodiments, the agent updates the authentication status and stores the member ID for subsequent steps upon successful authentication. In some embodiments the agent makes an API call to the CRM's authentication endpoint using a POST request to verify credentials. Upon verifying the credentials, the agent logs an event indicating successful authentication, enabling audit trails and triggering downstream steps.

In some embodiments, the AI Agent collects the member's new address through a conversational interface. In some embodiments, the agent gathers input (e.g., a user address) from the user, typically via chat or SMS. The collected address is stored in an address variable for use in subsequent validation and update steps. In some embodiments, there can be specified input fields (e.g., address line, city, state, zip code, etc.) to collect, ensuring comprehensive address information is gathered.

In some embodiments, the AI Agent collects the member's new address through a conversational interface. The type section can indicate that task involves gathering input from the user, typically via chat or SMS. The context section can indicate the collected address is stored in a current address variable for use in subsequent validation and update steps. The line action details section specifies the input fields to collect, ensuring comprehensive address information is gathered.

In some embodiments, the AI Agent validates the newly collected address against a validation API to ensure it is complete and accurate. In some embodiments, the step includes a classifition as a data validation task. The agent reads the collected address, validates it, and updates the validation status accordingly. In some embodiments, there can be different commands to indicate the validation service to use and define an error-handling routine that notifies the member if the address fails validation.

In some embodiments, the AI Agent updates the validated address in the enterprise CRM system. In some embodiments, this operation is classified as an external system interaction via an API. The agent reads the member ID and validated address, submits the update to the CRM, and logs the update status. In some embodiments, the command defines the API endpoint and method (e.g., POST) for the CRM integration.

In some embodiments, the AXA Declaration enables agentic execution through autonomous execution, dynamic adaptation, context-aware processing, and compliance and auditability. For example, the AI Agent autonomously performs each step, making real-time decisions based on the context and validation results, in some embodiments. If the address validation fails, the agent follows predefined error-handling protocols to notify the member and request corrections. In some embodiments, the agent maintains state awareness across steps, ensuring data is correctly passed from authentication to final CRM integration. Each action, from authentication to address update, is logged with timestamps, ensuring compliance with data governance policies.

This AXA Declaration exemplifies the agentic capabilities of the AXA platform, showcasing how AI Agents can autonomously manage multi-step workflows with dynamic decision-making and context-aware execution. The structured approach, combining authentication, data collection, validation, and external integration, highlights the technical sophistication of the AXA system. By embedding declarative logic into workflow execution, AXA offers a novel framework for experience automation that strengthens the solution's scope and defensibility.

In some embodiments, the AXA Declarations include a workflow for downloading a member card. The below AXA Declaration outlines the workflow for an AI Agent to autonomously handle the download of a digital insurance card. The process includes member authentication and retrieval of the digital card from an integrated CRM system. The declarative structure enables the agent to execute these steps dynamically, ensuring a secure, efficient, and context-aware experience for the user.

In some embodiments, the intent block defines the primary objective of the workflow (e.g., enabling the member to securely download their digital insurance card). In some embodiments, the intent block also includes a description (e.g., “Allow the member to download their digital insurance card”) that provides a concise explanation of the workflow's purpose, emphasizing user convenience and digital access to important documents.

The steps block outlines the sequential steps the AI Agent must perform to fulfill the intent. Each step specifies the task type, contextual data handling, and API integration details, ensuring the workflow operates autonomously and securely.

In some embodiments, the authenticate member ensures that only authorized members can access and download their digital insurance card. In some embodiments, the authorization is classified as a security step, critical for safeguarding sensitive member data. In some embodiments, the step block includes a description (e.g., “Validate member identity using CRM webhook”) that specifies that the authentication process is handled via a CRM webhook, ensuring the system adheres to enterprise security protocols. In some embodiments, once authenticated, the agent updates the authentication status and retrieves the member's unique ID for the next steps. In some embodiments, the agent sends a POST request to the /auth endpoint of the CRM to validate the member's credentials.

In some embodiments, an example fetch member card block retrieves the digital insurance card from the CRM system after successful authentication. The type section can indicate the task involves integrating with the CRM system to fetch the member's data. The line description of “Retrieve the member's digital card from the CRM system” defines that the AI Agent will obtain the digital card link from the CRM after verifying the member's identity. The line context section can indicate the agent reads the member identification to identify the correct account and updates the workflow with the retrieved digital card link. The action details section indicates the agent performs a GET request to the/fetch-card endpoint to retrieve the member's digital card.

In some embodiments, the AXA Declaration enables agentic execution through autonomous workflow handling, dynamic adaptation, context-aware processing, and seamless integration. For example, the AI Agent executes both steps autonomously—first ensuring secure authentication and then retrieving the digital card without human intervention, in some embodiments. If authentication fails, the agent can trigger error-handling protocols (not explicitly shown here), such as notifying the member or requesting additional verification. The agent maintains state awareness by updating the authentication status and linking it to the digital card retrieval process, ensuring that the right data flows through each step, in some embodiments. The workflow demonstrates how AI Agents interact with external CRM systems via APIs, allowing for real-time data retrieval and process automation.

This AXA Declaration exemplifies how the AXA platform enables AI Agents to perform secure, autonomous tasks like downloading sensitive documents through context-aware, declarative workflows. The combination of authentication protocols, API integrations, and dynamic context management reflects the technical sophistication and adaptive capabilities of the platform. By embedding these agentic behaviors into the execution framework, AXA offers a novel solution for experience automation that strengthens the solution's breadth and defensibility.

In some embodiments, the AXA Declaration defines the workflow for an AI Agent to autonomously handle the process of changing a member's Primary Care Physician (PCP). The workflow is designed to ensure a secure, personalized, and efficient experience by guiding the member through authentication, data collection, physician selection, and system update steps. Each step is executed dynamically, with the AI Agent adapting in real-time based on the member's input and system responses.

In some embodiments, the intent block includes a name (e.g., “Change Primary Care Physician”) that defines the primary objective of the workflow: enabling the member to select and update their Primary Care Physician (PCP). The description “Allow the member to select a new primary care physician” provides a clear explanation of the task, focusing on giving members the ability to personalize their healthcare choices.

In some embodiments, the steps block outlines the sequential tasks the AI Agent will autonomously execute to complete the workflow. Each step specifies the type of action, contextual data management, and integration details for seamless execution.

In some embodiments, an example authenticate member block ensures that the member's identity is securely verified before making any changes to their healthcare information. The type section classifies this step as a security validation process. The context section indicates the AI Agent updates the authentication status and stores the member ID for use in the following steps. The action details section indicates the agent sends a POST request to the authentication endpoint (/auth) to validate the member's credentials.

In some embodiments, an example search physician block gathers the member's preferences for selecting a new PCP, ensuring the physician matches their needs. The type section indicates the block involves collecting input from the member through a conversational interface (e.g., chat, SMS). The context section indicates the agent stores the collected preferences as search criteria for the physician lookup. The line action details specifies the input fields to be collected, such as the desired specialty, location, and gender preference of the physician.

In some embodiments, the select physician searches for physicians based on the collected preferences and display available options to the member. The “Integration” type indicates the block involves interacting with an external system (e.g., CRM, healthcare network) to retrieve available physicians. The context section indicates the agent reads the search criteria and updates the workflow with the selected physician chosen by the member. The action details section indicates the agent sends a GET request to an endpoint for searching physicians to retrieve physician options. The validation section indicates the agent validates whether the selected physician is available. If not, the member is notified to select another option.

In some embodiments, update PCP section finalizes the process by updating the member's Primary Care Physician in the healthcare or insurance system. The “Integration” type indicates the PCP section involves updating the external system to reflect the member's new PCP selection. The context section indicates the agent reads the member ID and selected physician data, performs the update, and logs the PCP update status. The line action details indicates the agent submits a POST request to the endpoint for updating the PCP to finalize the PCP update.

In some embodiments, the AXA declaration enables agentic execution through autonomous task handling, dynamic adaptation, context-aware processing, and error handling. The AI Agent handles all steps—authentication, data collection, physician selection, and system update—without human intervention, in some embodiments. The workflow allows for real-time adjustments based on member input (preferences) and system responses (e.g., physician availability). The agent maintains a consistent context throughout the workflow, ensuring data is passed accurately between steps. The agent can handle errors (e.g., unavailable physicians) autonomously by notifying the member and offering alternative options.

This AXA Declaration illustrates the platform's ability to execute complex, multi-step healthcare workflows autonomously, with a focus on personalization, data security, and system integration. The declarative structure ensures that AI Agents can adapt dynamically, handle errors, and maintain context-awareness, distinguishing AXA from traditional workflow automation platforms. By embedding autonomous decision-making and dynamic integration into healthcare processes, this workflow strengthens the solution's scope, emphasizing AXA's technical innovation in experience automation.

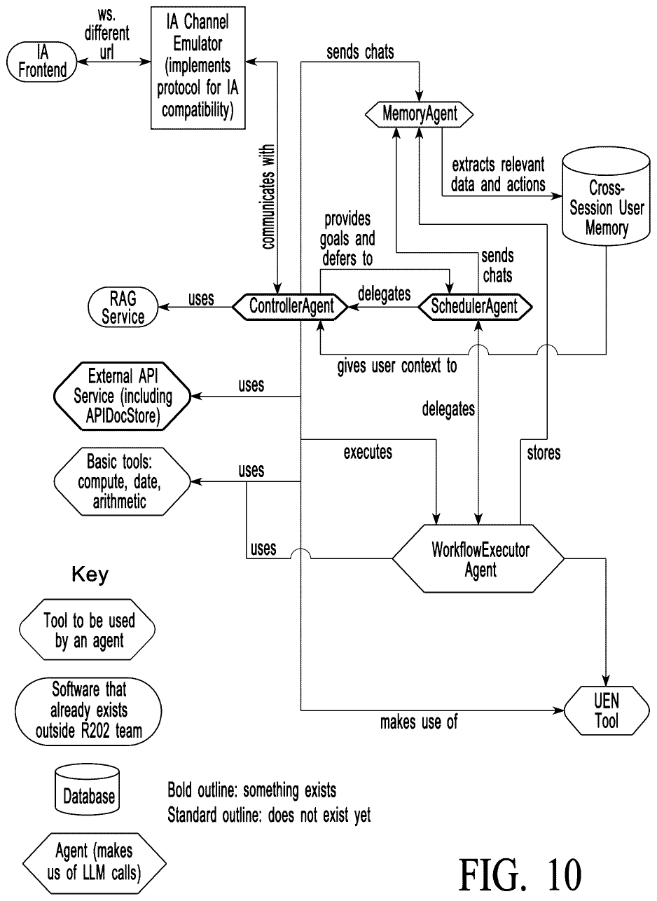

FIG. 10 illustrates a visual representation of how a multi-agent system (MAS) operates within the AXA platform, in accordance with some embodiments of the present disclosure.

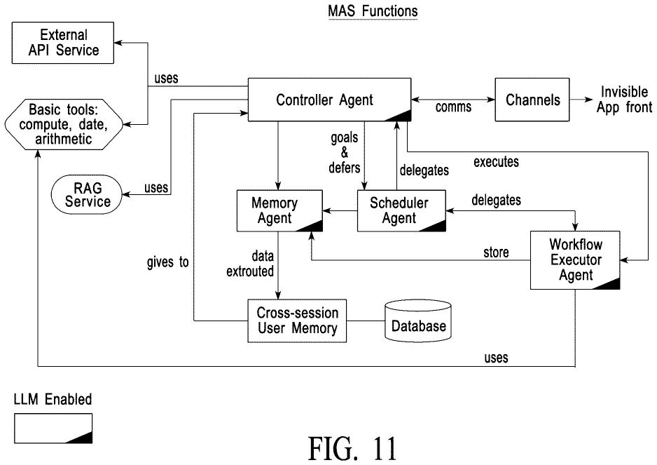

FIG. 11 illustrates a rendering of the MAS functions shown in FIG. 10 (excluding some proprietary terms), according to an alternate embodiment.

The illustrations in FIGS. 10-11 provide a visual representation of how the Multi-Agent System (MAS) operates within the AXA platform. It highlights the flow of tasks, the coordination between different AI Agents, and how these agents interact with both internal systems and external integrations to execute workflows autonomously.

Core MAS Components includes a core controller, a task scheduler and a task executor:

The core controller is the central unit that orchestrates the overall workflow, delegating tasks to specialized agents based on the workflow's requirements. The task scheduler dynamically assigns tasks to available agents, optimizing task distribution based on agent capabilities and current system load. The task executor is the component responsible for the actual execution of tasks, ensuring agents complete their assigned roles efficiently.

The illustration shows multiple AI Agents, each specialized in distinct functions such as data collection, authentication, integration, and validation.

Arrows and lines connecting these agents suggest inter-agent communication for collaborative workflows, where agents share data, context, and updates in real time to achieve complex tasks.

External System Integrations include API Endpoints. The illustration references API interactions like “method”: “POST”, highlighting how MAS agents communicate with external systems (e.g., CRMs, EMRs, and third-party services) to retrieve or update information.

The proprietary channel based on a dynamic web app (proprietary app called the Invisible App) facilitates seamless user interactions and data exchanges, suggesting a specialized interface for managing communication between the MAS and end-users.

The RAG Service is integrated into the MAS, enabling agents to retrieve contextual information from knowledge bases, enhancing their ability to provide accurate and context-aware responses.

Workflow Examples in the Illustration show declarations for “Download Member Card.” The MAS coordinates agents to execute the workflow for downloading a member card, starting from authentication to retrieving the digital card from the CRM.

Another example is declarations for “Changing Physician.” The MAS handles the complex process of changing a primary care physician (PCP), from member authentication to physician selection and updating the member's healthcare information in the system.

The overall workflow includes task initiation, task assignment and execution and decision making. The workflow starts with a trigger or user request, which is processed by the Core Controller. The Task Scheduler dynamically assigns the request to the appropriate AI Agents, such as Authentication Agent, Data Collection Agent, and Integration Agent. The Task Executor ensures tasks are carried out, while agents can collaborate and make decisions based on real-time data and conditions retrieved via the RAG Service.

AI Agents interact with external systems via API calls, ensuring seamless data exchange with systems like CRMs and healthcare databases.

Upon task completion, agents update the Context Store with relevant data and log the workflow's status for audit and compliance purposes.

The illustration of the MAS Functions in FIG. 10 highlights the innovative architecture of the AXA platform. It demonstrates how autonomous agents collaborate to execute complex workflows, dynamically interacting with both internal context and external systems. The integration of RAG for contextual information retrieval and the use of proprietary channels like InvisibleApp (a proprietary dynamic web app) emphasize AXA's unique approach to experience automation, strengthening the solution's claim of technical novelty.

The Multi-Agent System (MAS) within the AXA platform is the core framework that enables autonomous, intelligent execution of complex workflows. MAS orchestrates a network of specialized AI Agents, each responsible for distinct tasks, collaborating dynamically to achieve enterprise goals without human intervention. This system goes beyond traditional automation by embedding context-awareness, decision-making, and adaptive behaviors directly into the execution process.

Core Components of MAS are the Core Controller (acts as the central command of the MAS, coordinating the activities of various AI Agents, manages the workflow execution flow, ensuring that each agent receives tasks based on their specialization and current system context), Task Scheduler (dynamically assigns tasks to the appropriate AI Agents based on real-time conditions, agent availability, and task complexity, ensures load balancing across agents to optimize performance and efficiency) and task executor (executes tasks assigned by the scheduler, utilizing the agent's specialized skills and capabilities, supports agentic behavior, allowing agents to make real-time decisions during task execution).

A Context Store maintains shared context information accessible by all agents, ensuring continuity and consistency across the workflow. Context includes data like member information, authentication status, and workflow states.

An API Store is a repository of integrations and endpoints that AI Agents can access to interact with external systems (e.g., CRM, EMR, payment gateways). It allows agents to dynamically select the appropriate API for task execution.

An Agent Gateway facilitates communication between AI Agents, enabling collaborative decision-making and task handoffs. It ensures that agents can operate both independently and in coordination with others as needed.

MAS Functionalities and Workflow Execution includes dynamic task delegation. MAS can determine whether a task should be executed agentically by AI Agents or delegated to the Micro-Engagement Engine for rule-based execution. This hybrid approach allows MAS to handle complex tasks while leveraging micro-engagements for simpler, repetitive processes.

MAS functionality also includes AI Agent collaboration and conflict resolution to complete workflows, sharing context and coordinating actions. In cases of conflicting tasks or decisions, MAS employs a conflict resolution mechanism to prioritize actions based on predefined rules or real-time data.

Context-Aware Decision Making is a hallmark of MAS functionality. Agents use data from the Context Store to make informed decisions, adapting workflows in real time based on changes in the environment or user inputs. For example: an agent updating a member's address will check the authentication status and eligibility criteria before proceeding.

MAS includes self-recovery mechanisms where agents can detect errors (e.g., API failures, data inconsistencies) and execute fallback actions (e.g., retrying the task, notifying the user). MAS continuously monitors agent performance and workflow progress, providing real-time insights into task execution, success rates, and system efficiency.

The Multi-Agent System (MAS) represents the technical backbone of the AXA platform, introducing a novel approach to workflow execution through autonomous, adaptive agents. Unlike traditional automation systems that rely on rigid, predefined rules, MAS enables dynamic task delegation, real-time decision-making, and collaborative agent behavior. The ability of MAS to integrate with both AI-driven workflows and rule-based micro-engagements highlights its hybrid flexibility and technical innovation, strengthening the solution's scope and defensibility.

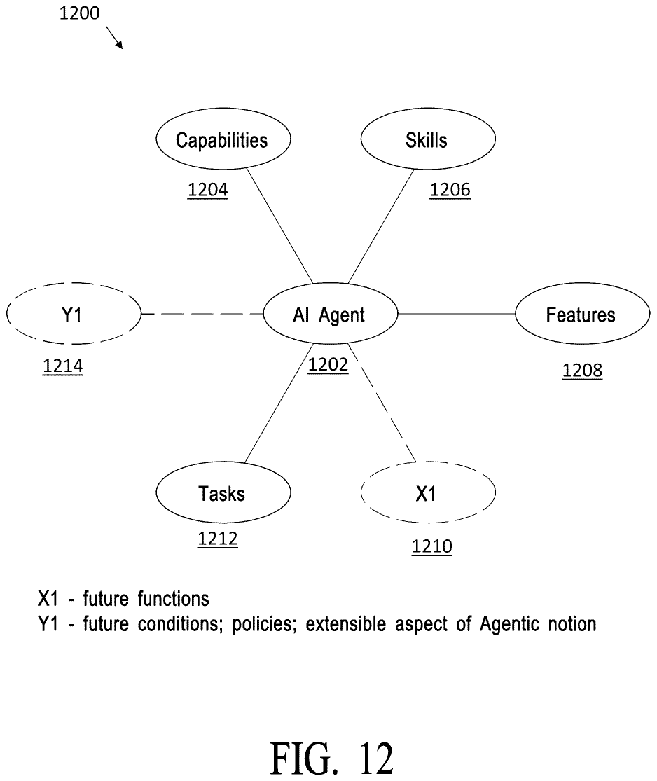

FIG. 12 illustrates an AI Agents and attributes architecture 1200, specifically extensible architecture for agentic notion. The AI agent architecture 1200 shows an AI agent 1202 at the center, connected to capabilities 1204, skills 1206, features 1208, and tasks 1212. Extensibility is for future functions 1210 (shown as X1) and for future policies and conditions 1214 (shown as Y1). Plug-in architecture supports the addition of new capabilities 1204 (i.e. future function X1 1210), examples of which can be IoT integration for smart health devices for healthcare, or predictive analytics for fraud detection in finance. Dynamic policy modules allow the system to adapt to regulatory changes (e.g., new HIPAA mandates, evolving GDPR rules) without reprogramming. This is an example of future condition and/or policy 1214 (Y1).

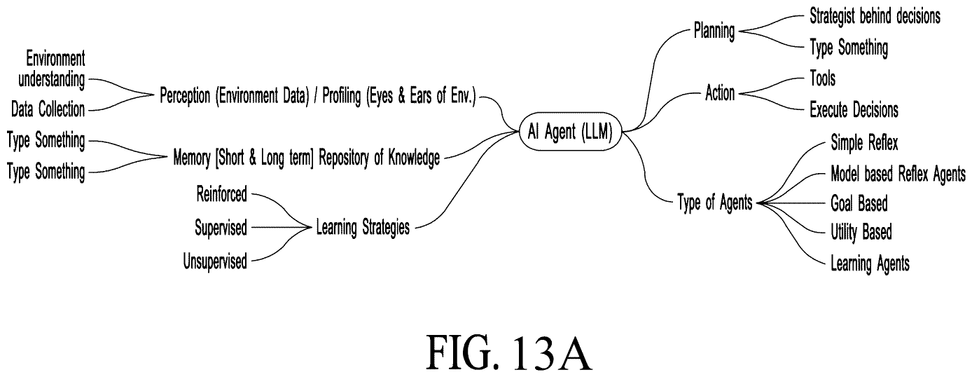

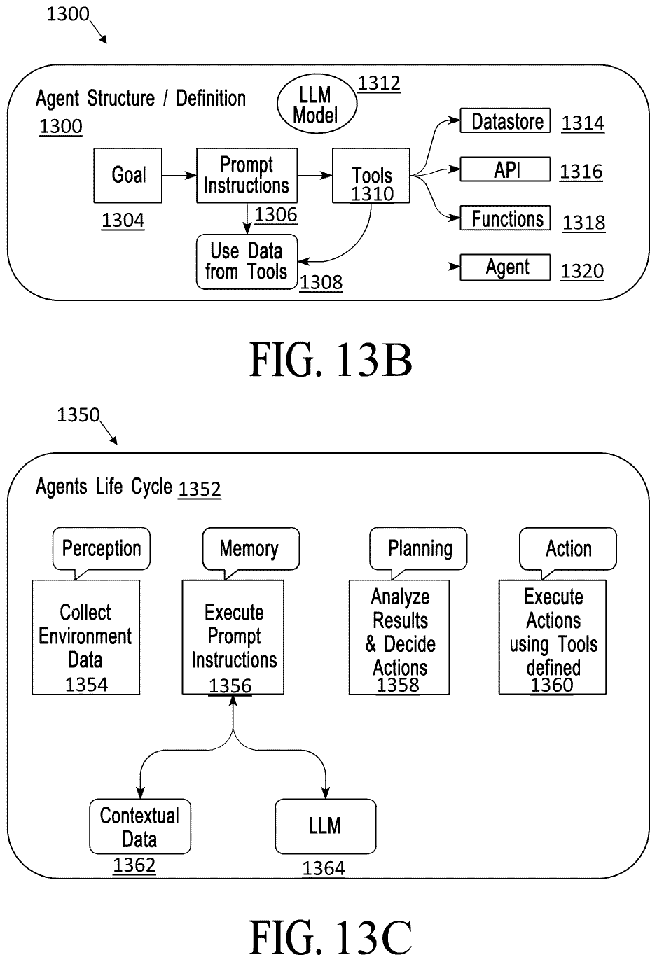

FIG. 13A illustrates functional architecture of an AI agent. The AI Agent in AXA is a modular, adaptive entity designed to handle industry-specific tasks autonomously.

FIG. 13B illustrates structure 1300 of an AI agent 1320, in accordance with some embodiments of the present disclosure. The structure includes Goals 1304, i.e., objectives defined by industry requirements (e.g., claims processing in insurance, regulatory reporting in finance). The structure also includes Prompt Instructions 1306 (i.e., AI Agents interact with vendor's language model 1312 using industry-specific prompts to guide reasoning). The structure also includes tools 1310, such as Data Store 1314, APIs 1316, Functions 1318, through which the AI Agents interface with external systems (e.g., EMRs, CRMs, financial databases) to retrieve data and perform actions. The structure also includes Agent Activities (i.e., collaboration with other agents within MAS) to handle complex, multi-step processes.

FIG. 13C illustrates lifecycle 1352 of an AI agent, in accordance with some embodiments of the present disclosure. The life cycle includes Perception phase 1354 for collecting industry-specific data from the environment (e.g., patient records, financial transactions). The next phase is Reasoning phase 1356, for executing prompt instructions and interacting with vendor's language model 1364 for context-aware decision-making. The next phase is Planning phase 1358. The agent analyzes the outcomes of its reasoning processes, comparing them against its goals and the current workflow state. It then decodes the next steps needed to achieve its objectives, planning a course of action that aligns with both the workflow requirements and workflow goals. The final phase is the Action phase 1360. This phase is for leveraging APIs and tools to execute tasks while ensuring security and compliance. This could involve updating records in a CRM, triggering notifications, retrieving documents, or even coordinating with other agents in the MAS to complete more complex workflows. In some embodiments, the life cycle also incorporates contextual data 1362 that informs the agent's decision making.

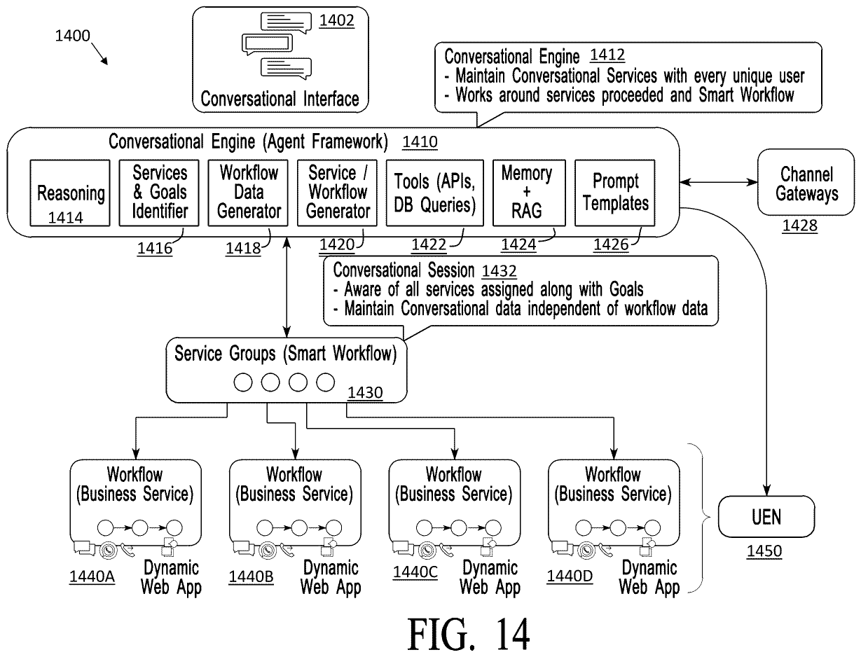

FIG. 14 illustrates an AI Agent system 1400 including a conversational interface 1402 and a conversational engine agent framework 1410 for execution within the conversational engine 1412 of the AXA platform, in accordance with some embodiments of the present disclosure. In addition to workflow execution, AXA integrates with a Conversational Engine 1412 where AI Agents manage natural language interactions tailored to specific industries. Conversational activities may include reasoning 1414 and a services and goals identifier 1416. An example is that the agent interprets user inputs to identify industry-specific intents (e.g., policy updates, appointment scheduling). Within the Conversational Engine 1412 there is workflow data generator 1418 and Service Generation module (e.g., workflow generator 1420), which enables the agents to dynamically generate or select services based on conversational context and regulatory frameworks. There is a tools module 1422 within the Conversational Engine 1412, through which the agents access APIs, databases, and knowledge bases to enhance responses. In some embodiments, the conversational engine 1412 also includes memory and RAG 1424 for retrieval-augmented generation capabilities. The agent utilizes both short-term memory (for session-specific context) and long-term memory (for historical data) to enhance its reasoning capabilities. RAG techniques are employed to retrieve relevant information from knowledge bases, ensuring accurate and contextually appropriate responses. The conversational engine 1412 also includes prompt templates 1426 for standardizing agent interactions, in some embodiments.

The Conversational Engine 1412 accesses industry-specific service groups 1430, allowing AI Agents to dynamically select workflows that align with regulatory and operational requirements. In some embodiments, once a workflow is selected, the agent breaks it down into manageable tasks, determining which steps require external system integration, user input, or autonomous decision-making. In some embodiments, conversational session 1432 maintains awareness of all services assigned along with goals and conversational data. In some embodiments, the service groups 1430 connect to workflow business services 1440A, 1440B, 1440C, and 1440D. Channel gateways 1428 facilitate communication across multiple channels, and a user/end-user network (UEN) 1450 connects to the channel gateways 1428 for end-user network interactions. The agent is also capable of adapting its conversation style based on user preferences, prior interactions, and current context, in some embodiments.

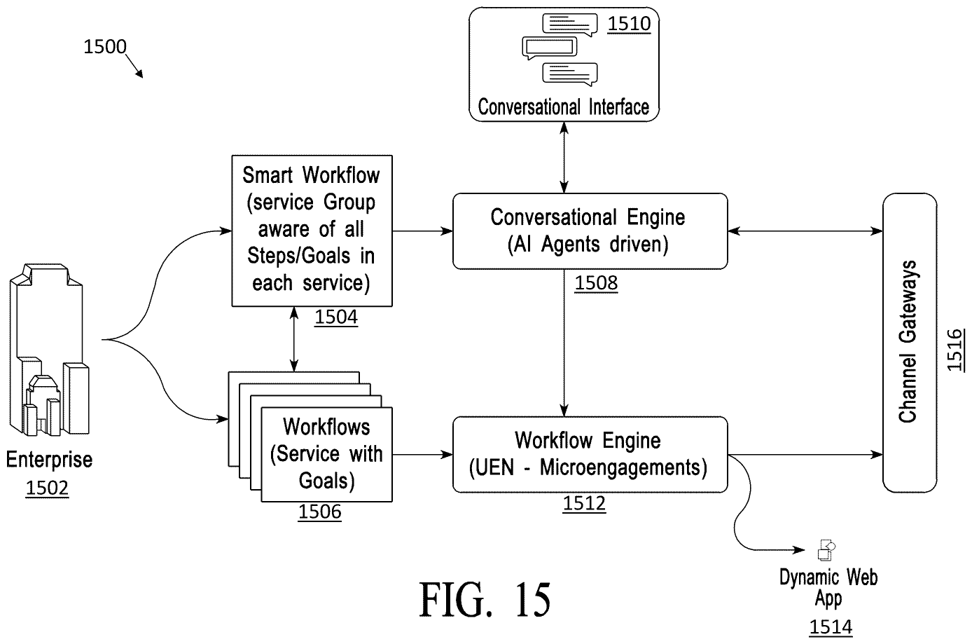

FIG. 15 illustrates an architecture 1500 showing how a traditional Micro-engagement Engine is unified with agentic notions, in accordance with some embodiments of the present disclosure. AXA introduces a hybrid automation model that blends rule-based micro-engagements with agentic execution frameworks. The Micro-Engagement Engine (e.g., workflow engine 1512) executes predefined, rule-based workflows 1506 ideal for tasks requiring strict adherence to industry regulations. AI Agents interpret workflows as intents, allowing for dynamic adaptation in non-regulatory contexts. An example of hybrid integration of the Micro-engagement engine 1512 and the agentic execution is when AI Agents dynamically delegate tasks to Micro-Engagement engines when compliance is critical, while maintaining agentic oversight for adaptable tasks. The architecture 1500 includes an enterprise 1502, a smart workflow 1504, workflows 1506, a conversational engine 1508, a conversational interface 1510, a dynamic web app 1514, and channel gateways 1516.

In some embodiments, the AI Agent interprets the intent behind the workflow and dynamically adjusts execution based on real-time conditions and contextual data. While the agent retains overarching control, it can delegate specific tasks to the workflow engine 1512 when rigid execution is beneficial. This includes bounded execution, where certain points within the workflow may be marked explicitly for micro-engagement execution, ensuring that critical steps are followed exactly as prescribed. The workflow engine 1512 may also be invoked for atomic operations, i.e., atomic, rule-based tasks such as data validation or authentication checks, even within an agentic workflow. As an example of hybrid execution, a workflow for updating a member's address might include dynamic, agentic steps for collecting and validating the new address, while the actual update to the CRM might be delegated to the workflow engine 1512 to ensure that the update follows strict data integrity protocols. This hybrid approach provides flexibility with predictability, combining the predictability of rule-based workflows with the flexibility of agentic execution.

In summary, Agentic Experience Automation (AXA) represents a significant advancement in experience automation, introducing Vertical AI Agents that dynamically adapt to industry-specific workflows, compliance requirements, and real-time data. By combining MAS architecture, UshurLLM reasoning, and AXA Declarations, AXA enables secure, context-aware, and autonomous workflow execution. The integration of micro-engagement engines with agentic processing provides a flexible, hybrid model that ensures both predictability and dynamic adaptability, while the extensibility framework ensures that the system remains scalable and future-proof across industries such as insurance, healthcare, and financial services.

FIG. 16 illustrates an example machine of a computer system 1600 within which a set of instructions, for causing the machine to perform any one or more of the methodologies discussed herein, can be executed. In some embodiments, the computer system 1600 can correspond to a host system that includes, is coupled to, or utilizes a memory sub-system or can be used to perform the operations of a processor (e.g., to execute an operating system to perform operations corresponding to agentic experience automation). Note that the agentic experience automation component 1613 may have sub-components, for example, a multi-agent system. In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1600 includes a processing device 1602, a main memory 1604 (e.g., read-only memory (ROM), flash memory, dynamic random access memory (DRAM) such as synchronous DRAM (SDRAM) or Rambus DRAM (RDRAM), etc.), a static memory 1608 (e.g., flash memory, static random access memory (SRAM), etc.), and a data storage system 1618, which communicate with each other via a bus 1630.

Processing device 1602 represents one or more processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1602 can also be one or more special-purpose processing devices such as an application specific integrated circuit (ASIC), a field programmable gate array (FPGA), a digital signal processor (DSP), network processor, or the like. The processing device 1602 is configured to execute instructions 1628 for performing the operations and steps discussed herein. The computer system 1600 can further include a network interface device 1616 to communicate over the network 1620.

The data storage system 1618 can include a machine-readable storage medium 1624 (also known as a computer-readable medium) on which is stored one or more sets of instructions 1628 or software embodying any one or more of the methodologies or functions described herein. The instructions 1628 can also reside, completely or at least partially, within the main memory 1604 and/or within the processing device 1602 during execution thereof by the computer system 1600, the main memory 1604 and the processing device 1602 also constituting machine-readable storage media. The machine-readable storage medium 1624, data storage system 1618, and/or main memory 1604 can correspond to a memory sub-system.

In one embodiment, the instructions 1628 include instructions to implement functionality corresponding to the agentic experience automation component 1613. While the machine-readable storage medium 1624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A multi-agentic system for executing workflows in an experience automation platform, the system comprising:
a memory; and
a set of one or more processing devices coupled to the memory, wherein the set of one or more processing devices is to perform operations comprising:
identifying a workflow corresponding to a user request;
determining a plurality of declarations corresponding to the workflow, wherein each of the declarations is associated with an artificial intelligence (AI) agent of a plurality of AI agents;
identifying a set of AI agents, wherein each AI agent in the set is associated with a declaration of the plurality of declarations;
assigning, to each of the set of AI agents, a respective declaration of the plurality of declarations for execution;
receiving, from each of the set of AI agents, data corresponding to the respective declarations;
generating, based on the received data, feedback corresponding to the workflow; and
providing, for presentation via a user interface of the experience automation platform, the generated feedback corresponding to the workflow.

2. The system of claim 1, wherein the declarations comprise one or more operations associated with the workflow and an intent of the workflow.

3. The system of claim 1, wherein each AI agent of the plurality of AI agents is associated with a business sector.

4. The system of claim 3, wherein identifying a set of AI agents comprises:
determining a business sector corresponding to the plurality of declarations; and
identifying an AI agent associated with the determined business sector.

5. The system of claim 3, wherein a business sector comprises at least one of insurance, healthcare, or financial services.

6. The system of claim 1, wherein the operations further comprise:
providing additional data to an AI agent of the set of AI agents;
receiving one or more modifications corresponding to the workflow from the AI agent;
determining one or more additional declarations based on the one or more modifications; and
transmitting, to each of one or more AI agents, a respective additional declaration of the one or more additional declarations.

7. The system of claim 6, wherein the one or more modifications comprise at least one of:
updating an execution time of one or more operations;
adding one or more additional operations;
removing one or more operations; or
updating one or more workflow parameters.

8. The system of claim 1, wherein the operations further comprise:
maintaining a context store comprising member information, authentication status, and workflow states, wherein the context store is accessible to the plurality of AI agents.

9. The system of claim 1, wherein the plurality of AI agents comprise at least one of an authentication agent, a data collection agent, or an integration agent.

10. The system of claim 1, wherein the feedback comprises at least one of:
interaction metrics;
a workflow success rate; or user satisfaction rates.

11. The system of claim 1, wherein the operations further comprise:
maintaining a repository of pointers corresponding to external systems accessible to the plurality of AI agents.

12. The system of claim 1, wherein the system further comprises:
a language model to provide reasoning support to the plurality of AI agents during execution of the respective declarations.

13. The system of claim 1, wherein each AI agent of the plurality of AI agents comprises one or more modular skills, wherein the one or more modular skills comprise at least one of:
text classification;
information extraction;
knowledge base comprehension; or
retrieval-augmented generation.

14. The system of claim 1, wherein the operations further comprise:
configuring a persona profile for an AI agent of the plurality of AI agents, wherein the persona profile comprises one or more of tone, formality, empathy, or proactivity attributes.

15. The system of claim 1, wherein the system further comprises:
one or more plug-in modules to add one or more additional capabilities to the plurality of AI agents; and
one or more dynamic policy modules to adapt to regulatory changes.

16. The system of claim 1, wherein identifying the workflow comprises:
receiving, from an AI agent of the plurality of AI agents, the workflow selected from a service group of a plurality of service groups, wherein the service group is determined based on a user goal corresponding to the user request.

17. The system of claim 1, wherein the operations further comprise:
identifying a portion of the workflow for rule-based execution;
delegating the identified portion to a micro-engagement engine for execution; and
receiving, from the micro-engagement engine, a result of the execution of the identified portion.

18. The system of claim 1, wherein the system further comprises:
an agent gateway to facilitate communication between the plurality of AI agents.

19. A method for executing workflows in an experience automation platform, the method comprising:
identifying a workflow corresponding to a user request;
determining a plurality of declarations corresponding to the workflow, wherein each of the declarations is associated with an artificial intelligence (AI) agent of a plurality of AI agents;
identifying a set of AI agents, wherein each AI agent in the set is associated with a declaration of the plurality of declarations;
assigning, to each of the set of AI agents, a respective declaration of the plurality of declarations for execution;
receiving, from each of the set of AI agents, data corresponding to the respective declarations;
generating, based on the received data, feedback corresponding to the workflow; and
providing, for presentation via a user interface of the experience automation platform, the generated feedback corresponding to the workflow.

20. The method of claim 19, wherein the declarations comprise one or more operations associated with the workflow and an intent of the workflow.
